(19) United States
(12) Patent Application Publication
(10) Pub. No.: US 2024/0029026 A1
(43) Pub. Date: Jan. 25, 2024

(54) RECOMMENDATION SYSTEM AND METHOD FOR INCORPORATING DESIGN THINKING FRAMEWORKS IN PROJECTS

(71) Applicant: Aditi Sharma, New Delhi (IN)

(72) Inventor: Aditi Sharma, New Delhi (IN)

(21) Appl. No.: 18/225,532

(22) Filed: Jul. 24, 2023

(30) Foreign Application Priority Data
Jul. 24, 2022 (IN) 202211042328

(51) Int. Cl. G06Q 10/10; G06Q 10/0631; G06F 40/40

(52) U.S. Cl. CPC G06Q 10/103; G06Q 10/06313; G06F 40/40

(57) ABSTRACT

A recommendation system and method for incorporating design thinking frameworks in a project is disclosed. The recommendation system comprises a memory and a processor configured to perform functions. The functions comprise providing questions to a user device and receiving responses corresponding to the questions from the user device. The functions also comprise determining input values corresponding to predefined input parameters for a model based on the responses and comparing the input values with predefined input values provided corresponding to the predefined input parameters. Further, the functions comprise identifying peers based on the comparison and determining output values corresponding to predefined output parameters of the model. In addition, the functions comprise generating the design thinking frameworks based on the output values and providing the design thinking frameworks to the user device. The method comprises steps performed by the recommendation system.

### CROSS REFERENCE TO RELATED APPLICATIONS

This application claims the benefit of India Application No. 202211042328, filed in India on Jul. 24, 2022, which is hereby incorporated herein by reference.

### TECHNICAL FIELD

The present disclosure, in general, relates to design thinking processes. More particularly, the present disclosure relates to a recommendation system and method for incorporating design thinking frameworks in projects.

### BACKGROUND

In recent times, digital experiences such as, but not limited to, websites, online games, and other interactive platforms, have become complex and ‘feature-rich’ with many options and functional capabilities available to a user. However, for such digital experiences to be effective and/or useful, an in-depth understanding of human-centered designs or user experience (UX) designs may be necessary and, in some instances, may be critical and/or a requirement. To this end, according to Design Management Institute, companies providing such digital experiences with focus on a user-centered design thinking process outperformed other companies by about 200% in terms of user adoption, user acquisition, user engagement, conversion from free to paid users, and/or user retention. Further, the user-centered design thinking process allows for testing with customers prior to product release, and companies benefit not just in terms of the user adoption but also in term of cost savings. This is because fixing an error post development of the digital experiences may be more expensive as compared to expenses incurred before the development. Therefore, the companies that tend to invest in the user-centered design thinking processes in product development may have reduced development risks, and improved speed, cost, and effort utilization. For example, a report published by McKinsey on the business value of design in product development found that businesses or companies that incorporate design thinking techniques and/or methodologies in product development reported 4 times more revenue, 5 times cost savings, 6 times faster go-to-market speeds, and 26 time more market valuation in comparison to businesses that did not implement the design thinking techniques and/or methodologies. Furthermore, according to International Data Corporation (IDC), companies invested 1.85 trillion worldwide in digital transformation initiatives in 2022. With a 16.3% Compounded Annual Growth Rate (CAGR), the IDC indicates that digital transformation spending by companies is projected to nearly double by 2026. The IDC also indicates that the United States alone will account for 35% of global digital transformation (DX) spending and could pass the $1 trillion mark in 2025. Further, the IDC indicates that 74% of organizations consider digital transformation a priority and 97% of companies say that the COVID-19 pandemic sped up the digital transformation initiatives within the companies. In addition, the IDC also indicates that 77% of companies have already started their digital transformation journey, and yet only 35% of organizations' digital transformation efforts are successful. The reason for a higher percentage of the companies that are unable to implement the digital transformation successfully can be attributed to a lack of understanding of the user-centered design thinking processes which require expertise, collaboration, agility, and in-depth research mechanisms to balance customer and business needs.

### SUMMARY

In an aspect of the present disclosure, a recommendation system for incorporating one or more design thinking frameworks in a project is disclosed. The recommendation system comprises a memory to store instructions and a processor. The processor is configured to execute the instructions stored in the memory to perform one or more functions. The functions comprise providing one or more questions associated with the project, an entity associated with the project, or both the project and the entity to a user device via the network. The functions also comprise receiving one or more responses corresponding to the questions from the user device via the network. Further, the functions comprise determining one or more input values corresponding to one or more predefined input parameters for a model based on the responses. The functions also comprise comparing the input values determined with one or more predefined input values provided corresponding to the one or more predefined input parameters. The predefined inputs provided are associated with one or more predefined projects and/or one or more predefined entities. In addition, the functions comprise identifying one or more peers associated with project, the entity, or both the project and the entity based on the comparison using the model. The peers comprise at least one of one or more peer projects identified among the one or more predefined projects, one or more peer entities identified among the one or more predefined entities, or both the one or more peer projects and the one or more peer entities identified. The functions also comprise determining one or more output values corresponding to one or more predefined output parameters of the model based on the identification. The predefined output parameters are associated with the design thinking frameworks. Furthermore, the functions comprise generating the design thinking frameworks based on the output values determined. The functions also comprise providing the design thinking frameworks to the user device via the network.

In another aspect of the present disclosure, a method for incorporating one or more design thinking frameworks in a project is disclosed. The method comprises a step of providing, via a processor of a recommendation system, one or more questions associated with the project and/or an entity associated with the project to a user device via the network. The method also comprises a step of receiving, via the processor, one or more responses corresponding to the questions from the user device via the network. Further, the method comprises a step of determining, via the processor, one or more input values corresponding to one or more predefined input parameters for a model based on the responses. The method also comprises a step of comparing, via the processor, the input values determined with one or more predefined input values provided corresponding to one or more predefined input parameters. The predefined input parameters provided are associated with one or more predefined projects and/or one or more predefined entities. In addition, the method comprises a step of identifying, via the processor, one or more peers associated with project and/or the entity based on the comparison using the model. The peers comprise at least one of one or more peer projects identified among the one or more predefined projects and/or one or more peer entities identified among the one or more predefined entities. The method also comprises a step of determining, via the processor, one or more output values corresponding to one or more predefined output parameters of the model based on the identification. The predefined output parameters are associated with the design thinking frameworks. Furthermore, the method comprises a step of generating, via the processor, the design thinking frameworks based on the output values determined. The method also comprises a step of providing, via the processor, the design thinking frameworks to the user device via the network.

### BRIEF DESCRIPTION OF THE DRAWINGS

FIG. 1 is a schematic illustration of an exemplary environment including a recommendation system in communication with one or more user devices, in accordance with which various embodiments of the present disclosure may be implemented;

FIG. 2 is a schematic block diagram of the recommendation system of FIG. 1, in accordance with the embodiment of the present disclosure;

FIG. 3 is a schematic block diagram of one or more modules in a processor of the recommendation system of FIG. 2, in accordance with the embodiment of the present disclosure;

FIGS. 4-14 are exemplary schematic illustrations of different sets of questions and predefined responses provided by the recommendation system of FIGS. 1-2 to the user device of FIG. 1, in accordance with the embodiment of the present disclosure;

FIG. 15 is an exemplary schematic illustration of input values determined corresponding to predefined input parameters for a recommendation model provided in the recommendation system of FIGS. 1-2 based on the responses received from the user device of FIG. 1, in accordance with the embodiment of the present disclosure;

FIG. 16 is an exemplary schematic illustration of output values determined corresponding to predefined output parameters of a recommendation model by the recommendation system of FIGS. 1-2, in accordance with the embodiment of the present disclosure;

FIG. 17 is an exemplary illustration of a method for incorporating design thinking frameworks in a project, in accordance with the embodiment of the present disclosure; and

FIGS. 18-27 are exemplary illustrations of the design thinking frameworks for different projects provided by the the recommendation system of FIGS. 1-2 to the user device of FIG. 1 based on the responses received from the user device, in accordance with different embodiments of the present disclosure.

### DETAILED DESCRIPTION

Building a user-centered product/service requires understanding how users feel about a user interface system considering aspects such as, but not limited to, ease of use, perception of a value of the user interface system, utility of the user interface system, and efficiency in performing one or more tasks using the user interface system. Design thinking is a non-linear, iterative process that users and/or product development teams use to understand customers, challenge assumptions, redefine problems, and create innovative solutions to create, prototype, and/or test new products and/or services. The design thinking process involves phases of discovery, definition, design, and delivery. Design thinking is essential when defining a customer experience to guide the creation of the products and/or services to provide useful and relevant experiences to the users. An aspect of the design thinking process is User Experience (UX) which corresponds to how a user feels when interfacing with a website, a web application, desktop software, a mobile application, a videogame, and/or similar forms of human-computer interaction (HCl) presently in use and/or to be developed in future. The design thinking process helps businesses create digital and/or physical products and/or services that are useful, valuable, functional, memorable, viable, usable, and desirable for users.

Further, the design thinking process involves understanding of human behavioral patterns, instincts, tendencies, expectations, and/or limitations in order to gain insights which may provide new ways of analyzing a task or a problem, and help in deducing intuitive, counter-intuitive, and/or non-linear courses of action to implement to bring about preferred situations and/or generate solutions for disparate problems in a business and/or a society. The design thinking process also involves reframing perceived problems, challenges, and/or or tasks at hand, and gaining perspectives, in order to deduce the preferred situations and/or generate the solutions. The design thinking process also comprises, but is not limited to, collaborative, multi-disciplinary teamwork to utilize different skills, personalities, and thinking styles of individuals in a team to solve multifaceted problems. The design thinking process may employ divergent styles of thinking to deduce and/or generate different possible and/or probabile solutions by deferring judgment and creating an open ideation space to allow for maximum number of ideas and points of view to be considered. The design thinking process may also employ convergent styles of thinking to isolate potential solutions by combining and refining insights and ideas generated, which enable and/or aid in decision making. The design thinking process may also involve testing of selected ideas, rapidly modelling the potential solutions to aid iterative learning, and gaining additional insight into a viability of the potential solutions prior to investing time, effort, and monetary resources in product/service development. The design thinking process may also involve testing prototypes designed and/or manufactured based on the selected ideas to eliminate potential issues in the prototypes. The design thinking process may also involve iterating through various predefined stages by revisiting the product/service requirements and redefining the problems, tasks, and/or challenges as new knowledge emerges while gaining insight during customer interactions.

The present disclosure is directed towards a recommendation system for incorporating one or more design thinking frameworks in one or more projects. The design thinking framework(s) of the present disclosure may help set up a user-centric product design and/or innovation process at an organization with minimal specialized support. The design thinking framework(s) of the present disclosure may also help individuals involved in a product development process to become design thinking practitioners for generating, recommending, and/or measuring effectiveness of customized processes and templates. Particularly, the design thinking framework(s) of the present disclosure may comprise, but are not limited to, design thinking related process plans, process flow diagrams, project plans, team composition plans, projected project timelines, framework usage guidelines, presentations, and/or templates. The design thinking framework(s) of the present disclosure may help guide cross-functional project owners such as business partners, product managers, UX designers, and technology teams in incorporating and/or implementing design thinking concepts, techniques, and/or methodologies for product development. The design thinking framework(s) of the present disclosure may also be compatible with third-party tools, applications, and/or solutions implemented by such cross-functional project owners. In an embodiment, the third-party tools, applications, and/or solutions may provide stepped workflow guidance on how to facilitate completion of the tasks, problems, and/or challenges, and provide features such as, but not limited to, timeline tracking to integrate and/or incorporate the design thinking frameworks in predefined product development plans or projects provided and/or executed in the third-party tools, applications, and/or solutions.

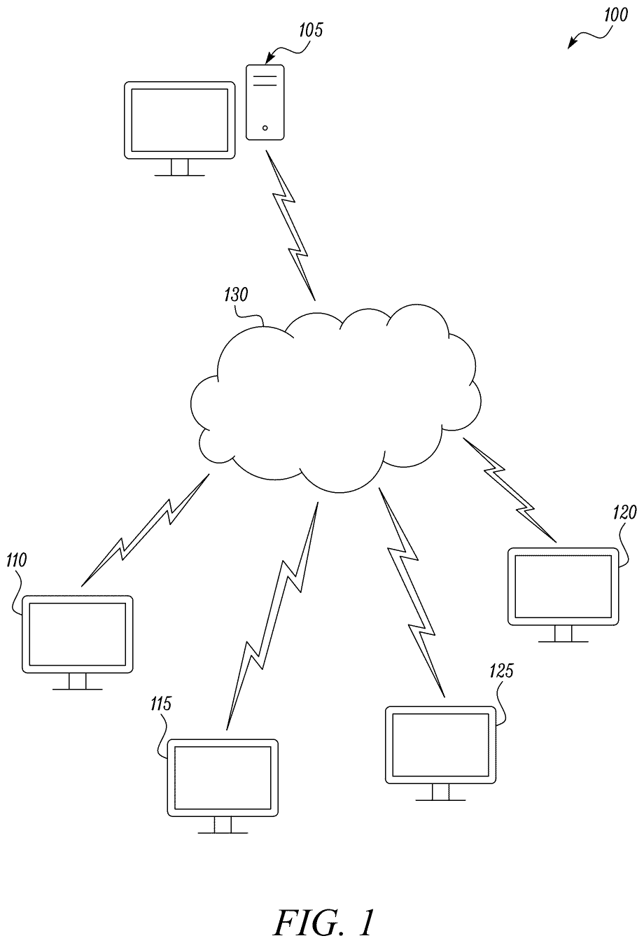

Referring to FIG. 1, a schematic illustration of an environment 100 is disclosed. The environment 100 comprises a recommendation system 105 and one or more user devices 110-125 in communication with the recommendation system 105 via a network 130. Examples of the recommendation system 105 and the user devices 110-125 include, but are not limited to, computers, laptops, mobile devices, handheld devices, personal digital assistants (PDAs), tablet personal computers, digital notebook, cloud computing devices, and similar electronic devices now known or developed in future. Examples of the network 106 include, but are not limited to, the Internet, a Wide Area Network (WAN) (for example, a transport control protocol/internet protocol TCP/IP) based network), a Wireless Local Area Network (WLAN), a cellular network, a Small Area Network (SAN), or a Local Area Network (LAN) employing any of a variety of communications protocols as is well known in the art.

For purposes of clarity, the user device 110 and the communication between the user device 110 and the recommendation system 105 via the network 130 will be explained herein and it may be appreciated that the same would also be applicable to the user devices 115-125. In an embodiment, the user device 110 may operate as an interface for a corresponding user interacting with the recommendation system 105. The user may utilize the user device 110 to provide one or more inputs and receive one or more outputs from the recommendation system 105 via the network 130. The user device 110 may include a plurality of electrical and electronic components that provide electrical power, operational control, content display, memory storage, communication, and the like within the user device 110. Further, although the recommendation system 105 and/or the user device 110 are shown and described to be implemented within single computing devices respectively, it may be contemplated that one or more components of the recommendation system 105 and/or the user device 110 may alternatively be implemented in a distributed computing environment, without deviating from the scope of the claimed subject matter. It will further be appreciated by those of ordinary skill in the art that the recommendation system 105 and/or the user device 110 alternatively may function within a remote server, cloud computing device, or any other local or remote computing mechanism now known or developed in the future.

In accordance with various embodiments, the recommendation system 105 is configured to generate and provide one or more design thinking frameworks to the user device 110. The user device 110 may incorporate the design thinking frameworks provided by the recommendation system 105 in one or more projects. Examples of the projects include, but are not limited to, a business and/or technical problem-solving projects, a Minimal Viable Product (MVP) launch projects, product feature enhancement projects, product pitches, User Interface (UI) development projects, product-market fit projects, market research projects, and/or customer research projects. In an embodiment, the design thinking frameworks may be employed as a plug-and-play model and/or service in the user device 110 such that the design thinking frameworks may be incorporated in system, native, and/or third-party applications provided in the user device 110. In some embodiments, the design thinking frameworks may also be provided as a standalone application independent of the system, native, and/or third-party applications that can be executed in the user device 110. In some embodiments, the design thinking frameworks may also be provided as a suite or collection of microservices that can accessed by the system, native, third-party, and/or stand-alone applications either directly in the user device 110 or via one or more Application Programming Interfaces (APIs). Such configurations of providing the design thinking frameworks enables the user device 110 belonging to an organization of any type or size such as, but not limited to, a large enterprise, small/medium enterprise, or a startup to access to the design thinking frameworks provided by the recommendation system 105.

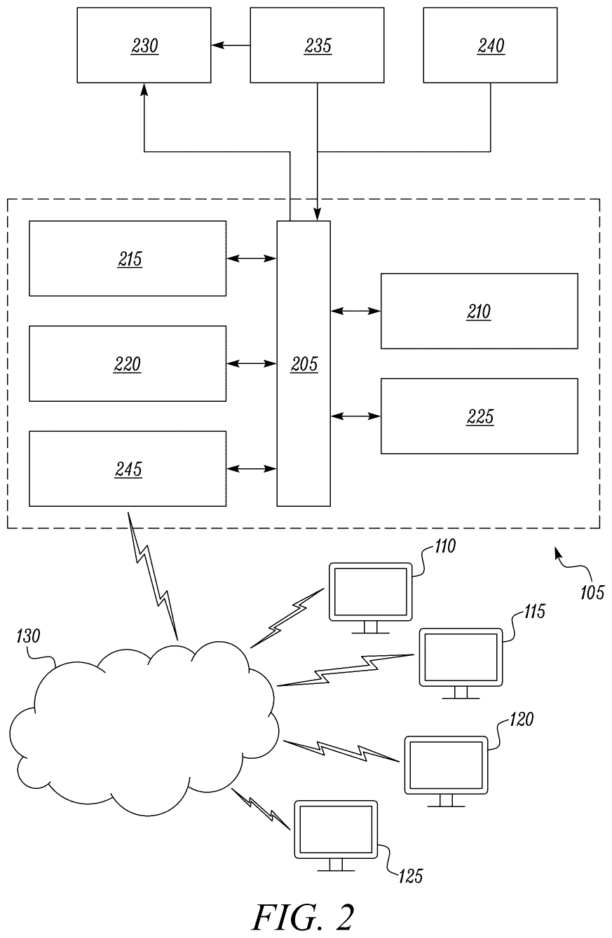

Referring to FIG. 2, a block diagram of the recommendation system 105 of FIG. 1 is disclosed. In some embodiments, the recommendation system 105 includes a bus 205 or other communication mechanism for communicating information, and a processor 210 coupled with the bus 205 for processing information. The recommendation system 105 also includes a memory 215, such as a random-access memory (RAM) or other dynamic storage device, coupled to the bus 205 for storing information and instructions to be executed by the processor 210. The memory 215 can be used for storing temporary variables or other intermediate information during execution of instructions to be executed by the processor 210. The recommendation system 105 further includes a read only memory (ROM) 220 or other static storage device coupled to bus 205 for storing static information and instructions for processor 210. A storage unit 225, such as a magnetic disk, optical disk, solid state or semiconductor memory, is provided and coupled to the bus 205. The storage unit 225 may store one or more resources such as, but not limited to, files, templates, plans, documents, knowledge repositories, databases, and predefined information associated with one or more design thinking frameworks. The storage unit 225 may also store one or more machine learning and/or artificial intelligence (AI) models, one or more predefined projects, one or more predefined entities, one or more predefined design thinking frameworks, and/or one or more predefined design thinking process related plans, templates, playbooks, diagrams, project plans, team composition plans, and/or project timelines, past/historic project completion trends, and/or framework usage guidelines associated with the predefined design thinking frameworks. The storage unit 225 may also store one or more predefined input and/or output parameters associated with the machine learning and/or AI models, one or more predefined input and output values corresponding to the predefined input and output parameters respectively provided corresponding to the predefined projects and/or the predefined entities. The storage unit 225 may also store one or more predefined questions associated with, but not limited to, the design thinking concepts, techniques, and/or methodologies, the predefined projects, and/or the predefined entities and/or also store one or more predefined responses provided corresponding to the predefined questions. Examples of the machine learning models include, but not limited to, a Natural Language Processing (NLP) and a k-Nearest Neighbour (k-NN) classification and/or regression model where k is a positive integer. In an embodiment, the storage unit 225 may store a recommendation model comprising the different machine learning models such as the NLP model and the k-NN model and the AI models. The machine-learning and/or AI models may correspond to mathematical models generated from computer algorithms based on predefined training data inputted, received, an/or retrieved from different data sources. In an embodiment, the predefined training data may comprise, but is not limited to, the predefined projects, the predefined entities, the predefined design thinking process plans, templates, playbooks, diagrams, project plans, team composition plans, project timelines, and past/historic project completion trends. The predefined entities may comprise, but are not limited to, entities associated with different ownership types, domains, organizational size, organizational structure, and organizational customer segments. The predefined projects may comprise, but are not limited to, predefined product development projects, predefined business and/or technical problem-solving projects, a Minimal Viable Product (MVP) launch projects, product feature enhancement projects, product pitch related projects, User Interface (UI) development projects, product-market fit projects, market research projects, and/or customer research projects. In an embodiment, storage unit 225 may also store account information related to one or more users and/or entities. Examples of the account information include, but are not limited to, user/entity login and/or access details, user/entity preferences, user/entity feedback, list of user/entity related third-party applications, and user/entity suggested modifications to design thinking frameworks. The user/entity login and/or access details may correspond to, but are not limited to, a secure and private access of the design thinking framework(s) provided to the users. The user preferences may correspond to, but are not limited to, user provided and/or defined product and/or service feature elements, user customized dashboards, framework usage data, product themes, collection of user interfaces, user preferred design thinking templates, and user provided project team members.

The recommendation system 105 can be coupled via the bus 205 to a display 230, such as a cathode ray tube (CRT), liquid crystal display (LCD), Light Emitting Diode (LED), and Organic LED (OLED), for displaying information to a user. An input device 235, including alphanumeric and other keys, is coupled to bus 205 for communicating information and command selections to the processor 210. Another type of user input device is a cursor control 240, such as a mouse, a trackball, or cursor direction keys for communicating direction information and command selections to the processor 210 and for controlling cursor movement on the display 230. The input device 235 can also be included in the display 230, for example a touch screen and/or a mobile keypad input device.

Various embodiments are related to the use of recommendation system 105 for implementing the techniques described herein. In one embodiment, the techniques are performed by the recommendation system 105 in response to the processor 210 executing instructions included in the memory 215. Such instructions can be read into the memory 215 from another machine-readable medium, such as the storage unit 225. Execution of the instructions included in the memory 215 causes the processor 210 to perform the process steps described herein.

The term “machine-readable medium” as used herein refers to any medium that participates in providing data that causes a machine to operate in a specific fashion. In some embodiments implemented using the recommendation system 105, various machine-readable media are involved, for example, in providing instructions to the processor 210 for execution. The machine-readable medium can be a storage media. Storage media includes both non-volatile media and volatile media. Non-volatile media includes, for example, optical or magnetic disks, such as storage unit 225. Volatile media includes dynamic memory, such as the memory 215. All such media must be tangible to enable the instructions carried by the media to be detected by a physical mechanism that reads the instructions into a machine.

Common forms of machine-readable medium include, for example, a floppy disk, a flexible disk, hard disk, magnetic tape, or any other magnetic medium, a CD-ROM, any other optical medium, punch cards, paper-tape, any other physical medium with patterns of holes, a RAM, a PROM, and EPROM, a FLASH-EPROM, any other memory chip or cartridge.

In another embodiment, the machine-readable medium can be a transmission media including coaxial cables, copper wire and fibre optics, including the wires that comprise the bus 205. Transmission media can also take the form of acoustic or light waves, such as those generated during radio-wave and infra-red data communications. Examples of machine-readable medium may include but are not limited to a carrier wave as describer hereinafter or any other medium from which the recommendation system 105 can read, for example online software, download links, installation links, and online links. For example, the instructions can initially be carried on a magnetic disk of a remote computer. The remote computer can load the instructions into its dynamic memory and provide the instructions over a telephone line using a modem. A modem local to the recommendation system 105 can receive the data on the telephone line and use an infra-red transmitter to convert the data to an infra-red signal. An infra-red detector can receive the data carried in the infra-red signal and appropriate circuitry can place the data on the bus 205. The bus 205 carries the data to the memory 215, from which the processor 210 retrieves and executes the instructions. The instructions received by the memory 215 can optionally be stored on storage unit 225 either before or after execution by the processor 210. All such media must be tangible to enable the instructions carried by the media to be detected by a physical mechanism that reads the instructions into a machine.

The recommendation system 105 also includes a communication interface 245 coupled to the bus 205. The communication interface 245 provides a two-way data communication coupling to the network 130. For example, the communication interface 245 can be an integrated service digital network (ISDN) card or a modem to provide a data communication connection to a corresponding type of telephone line. As another example, the communication interface 245 can be a local area network (LAN) card to provide a data communication connection to a compatible LAN. Wireless links can also be implemented. In any such implementation, the communication interface 245 sends and receives electrical, electromagnetic or optical signals that carry digital data streams representing various types of information.

The processor 210 is configured to execute the instructions stored in the memory 215 to perform the predetermined operations, for example the detailed functions of the recommendation system 105 as will be described hereinafter. The processor 210 may include one or more microprocessors, microcontrollers, DSPs (digital signal processors), state machines, logic circuitry, or any other device or devices that process information or signals based on operational or programming instructions. The processor 210 may be implemented using one or more controller technologies, such as Application Specific Integrated Circuit (ASIC), Reduced Instruction Set Computing (RISC) technology, Complex Instruction Set Computing (CISC) technology or any other similar technology now known or in the future developed.

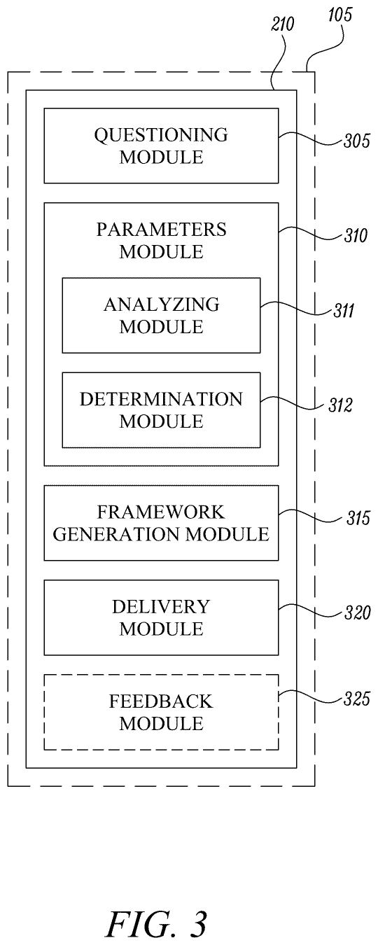

In an embodiment, the processor 210 of the recommendation system 105 may be capable of executing the computer instructions to perform one or more functions. In some embodiments, the processor 210 may be configured to execute one or more modules to perform the functions and may comprise hardware components and/or circuitry that facilitate the execution of the modules. In some embodiments, one or more modules may comprise both software and hardware components that enable the processor to perform the functions. For example, referring to FIGS. 2-3, the processor may comprise the modules comprising, but not limited to, a questioning module 305, a parameters module 310, a framework generation module 315, a delivery module 320, and a feedback module 325.

The questioning module 305 is configured to provide one or more questions associated with one or more projects and/or entities or organizations associated with the projects to the user device 110 via the network 130. In an embodiment, the questioning module 305 may be configured to provide the questions based on more predefined questions associated with design thinking, the predefined projects, and/or the predefined entities stored in the storage unit 225. The questioning module 305 is also configured to receive one or more responses corresponding to the questions respectively from the user device 110 via the network 130. Examples of the questions provided and/or the responses received include, but are not limited to, questions and/or responses related to one or more problems associated with the project(s) and/or one or more tasks in the project(s), a description of the tasks respectively, one or more types of the tasks, a level of user understanding of the design thinking concepts, techniques, and/or methodologies, a goal of the project (s) or one or more tasks included in the project (s), a priority associated with the tasks respectively, an order associated with the tasks respectively, an execution stage of the project(s) or the tasks, timelines associated with the project(s) or the one or more tasks, entity ownership type, entity size, entity structure, entity domain or industry, customer segment associated with the entity, team member(s) associated with the project(s), one or more development processes involved in the project(s), one or more types of the one or more development processes, information related to the design thinking framework(s) that is applicable to at least one of the tasks, the project(s), or the entity, one or more design thinking process plans applicable corresponding to the tasks or the problems associated with the tasks, sponsorship associated with the project(s), and/or a file format associated native, system, and/or third-party applications used and/or implemented in the user device 110.

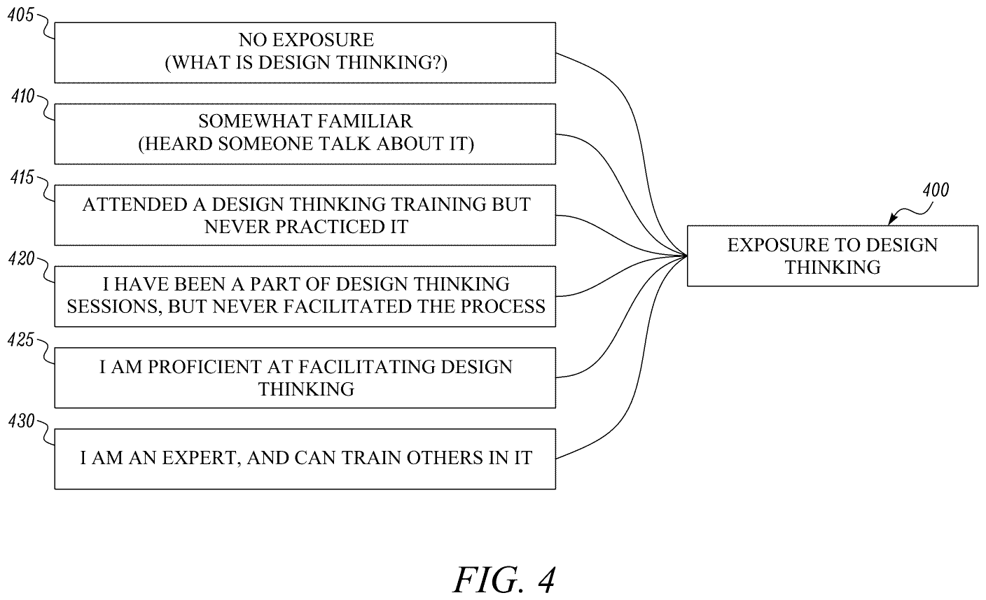

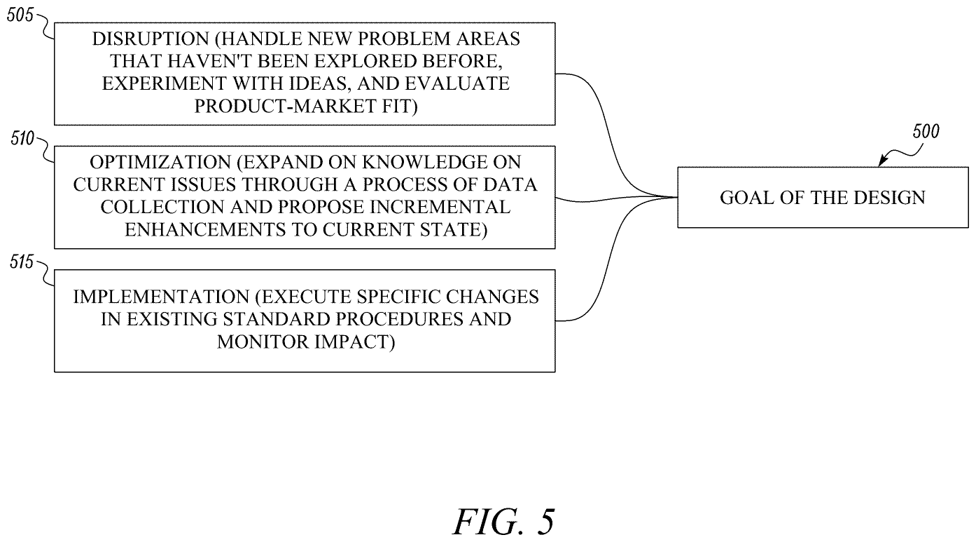

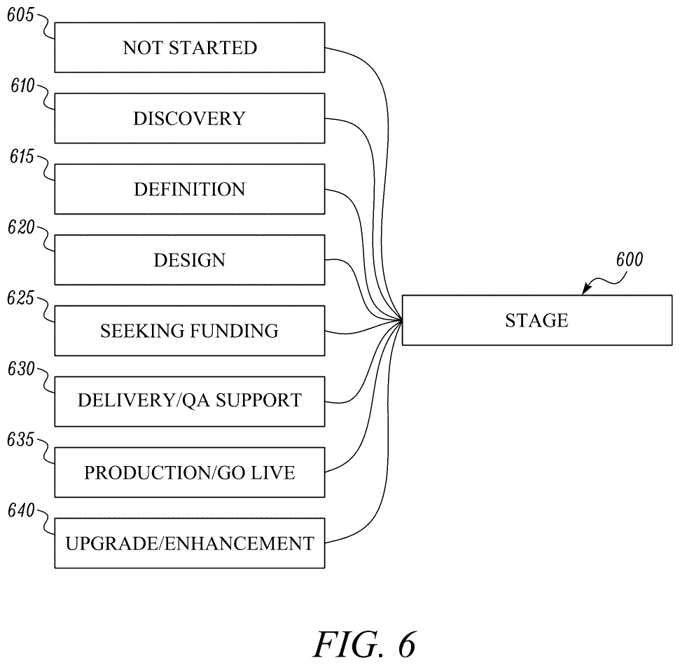

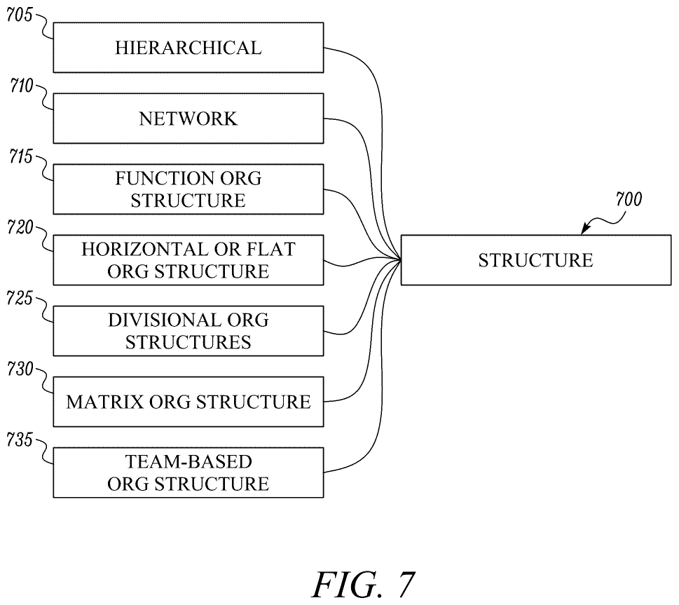

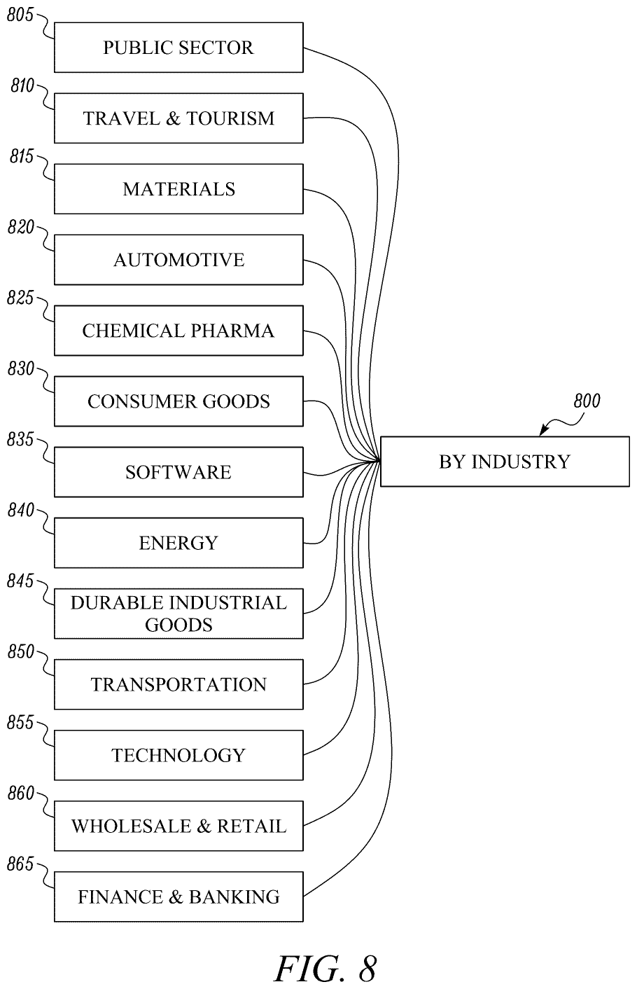

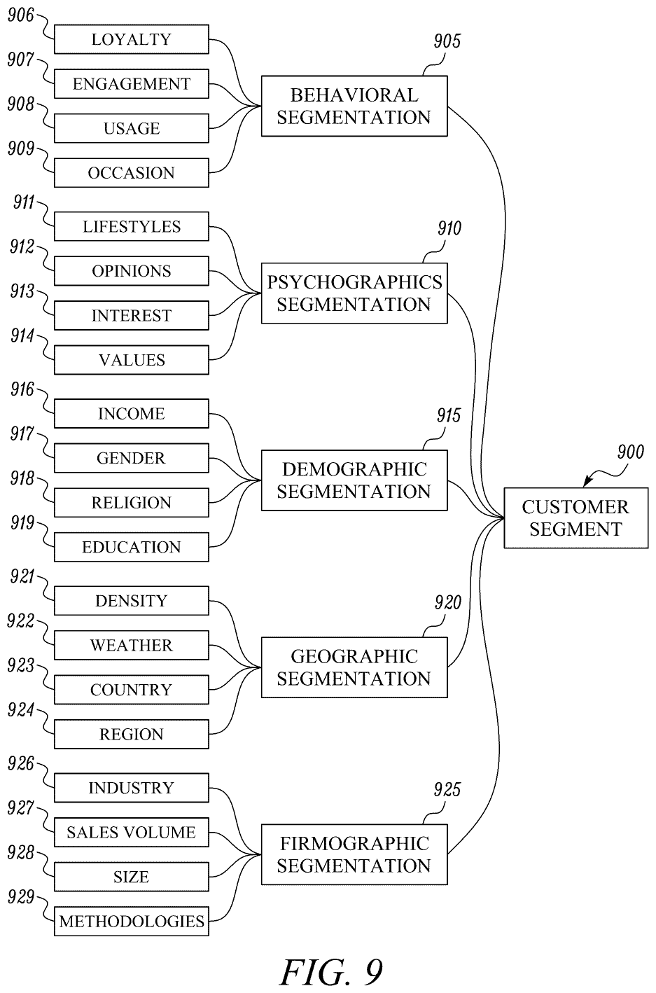

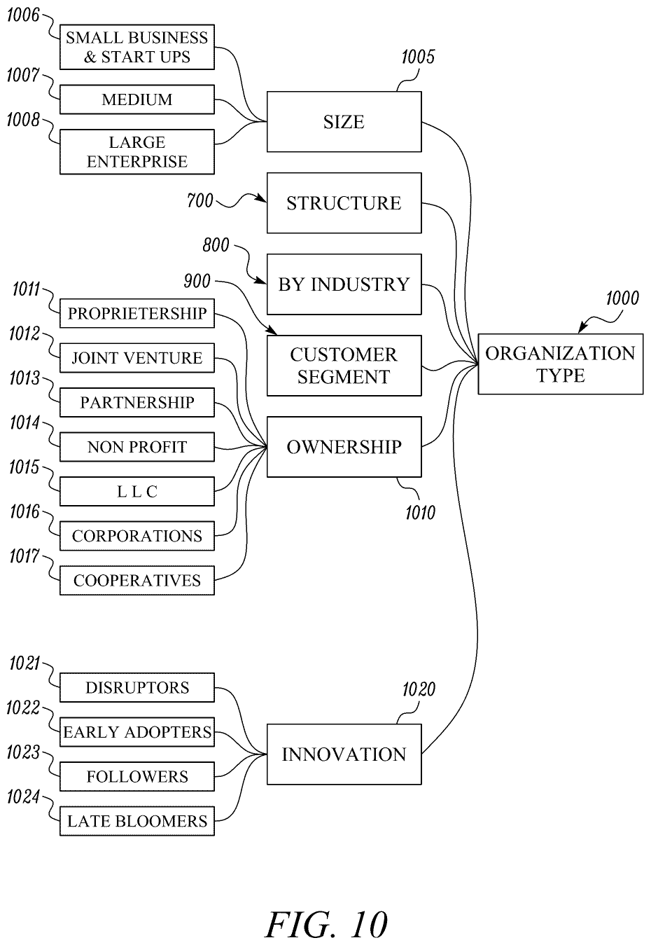

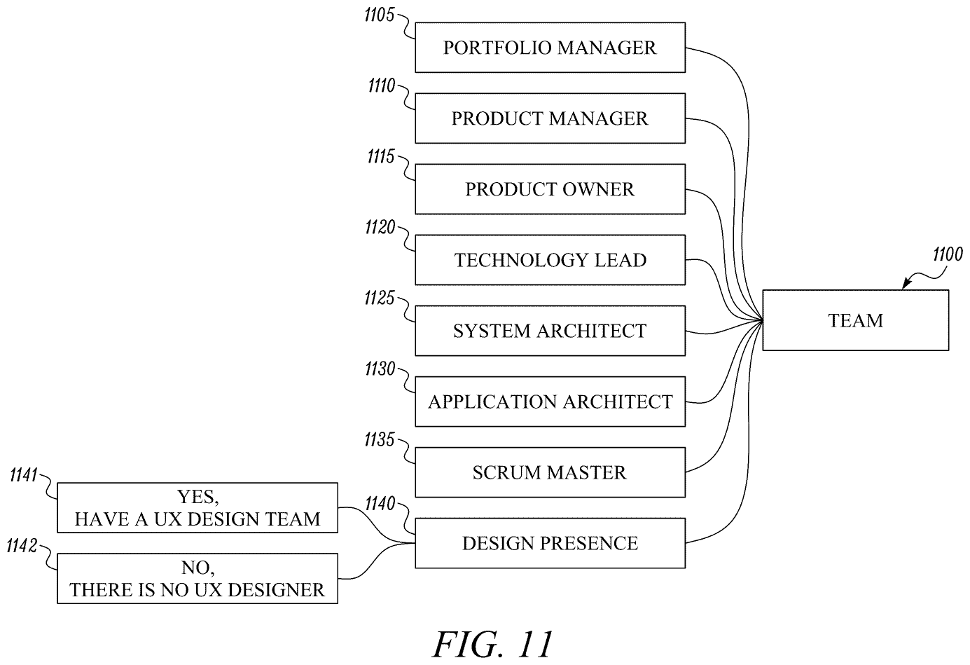

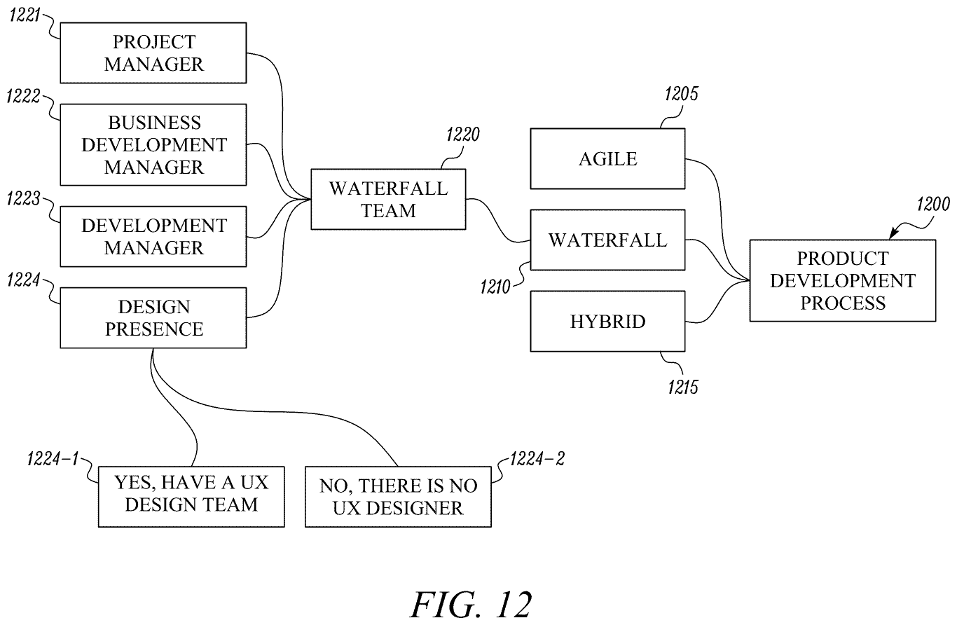

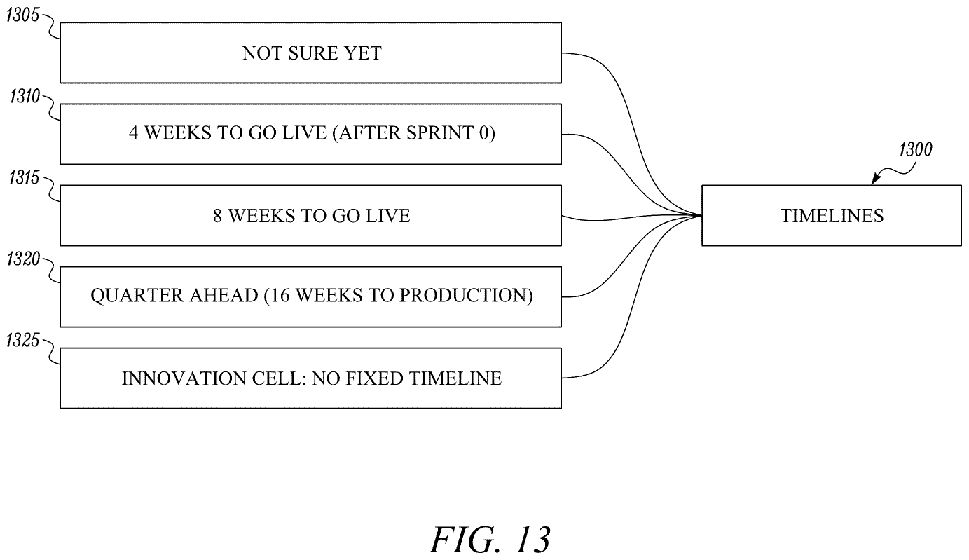

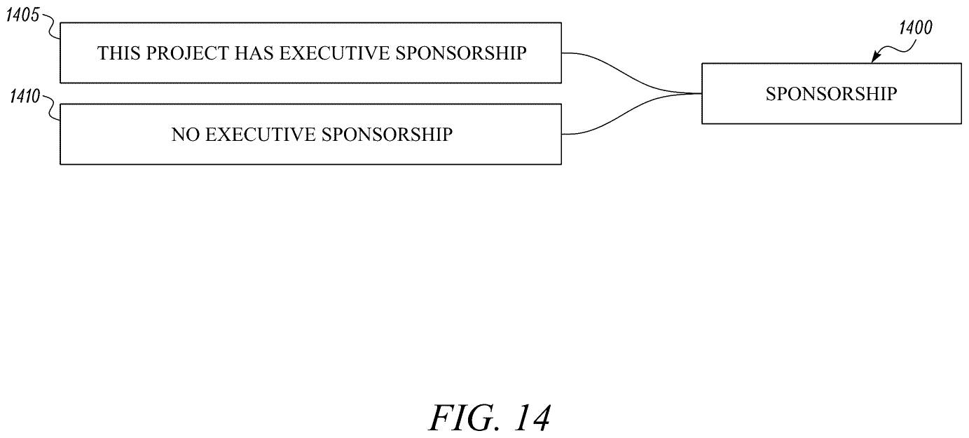

In some embodiments, the questioning module 305 may also be configured to provide one or more predefined responses corresponding to each question to enable the user to select an appropriate response from the responses provided in the user device 110 and in turn provide the selected response to the questioning module 305 via the network 130. In an embodiment, the questioning module 305 may provide the predefined responses based on the predefined responses stored in the storage unit 225. For example, referring to FIGS. 4-8, exemplarily the questioning module 305 may provide one or more questions related to user's exposure to design thinking or the level of user understanding 400 of the design thinking concepts, techniques, and/or methodologies, and the predefined responses 405-430 as shown in FIG. 4. Similarly, the questioning module 305 may provide one or more questions related to the goal 500 of the project(s) and the predefined responses 505-515 as shown in FIG. 5, questions related to the execution stage 600 of the project(s) and the predefined responses 605-640 as shown in FIG. 6, questions related entity or organization structure 700 and the predefined responses 705-735 as shown in FIG. 7, and questions related industry or domain 800 associated with the entity or organization and the predefined responses 805-865 as shown in FIG. 8. In some embodiments, the questioning module 305 (see FIG. 3) may provide a primary question, one or more secondary questions associated with the primary question, and one or more tertiary questions associated with the secondary questions. In an embodiment, the questioning module 305 may provide the primary, secondary, and the tertiary questions sequentially in that order. For example, referring to FIG. 9, the questioning module 305 may provide one or more primary questions associated with the customer segment 900 associated with the entity or organization, secondary questions 905, 910, 915, 920, and 925 associated with the customer segment 900, and tertiary questions 906-909, 911-914, 916-919, 921-924, and 926-929 associated with the secondary questions 905, 910, 915, 920, and 925 respectively. The questioning module 305 may also provide the one or more predefined responses corresponding to the primary, secondary, and tertiary questions respectively. In some embodiments, the questioning module 305 may provide a main question that may include one or more primary, secondary, and/or tertiary questions and associated predefined responses respectively. For example, referring to FIG. 10, the questioning module 305 may provide one or more main questions associated with the entity or organization type 1000 that may include the primary questions 700, 800, 900, as well as additional questions 1005 with the predefined responses 1006-1008, questions 1010 with the predefined responses 1011-1017, and questions 1020 with the predefined responses 1021-1024. Similarly, referring to FIG. 11, the questioning module 305 may provide one or more primary questions associated with the team 1100 involved or included in the project(s) and secondary questions 1105-1140 associated with the team. The questioning module 305 may also provide the one or more predefined responses corresponding to the primary and secondary questions respectively. For example, the questioning module 305 may provide the predefined responses 1141-1142 corresponding to the secondary question(s) related to design presence 1140. Further, referring to FIG. 12, the questioning module 305 may provide one or more main questions associated with the product development process 1200 that may include primary questions 1205, 1210, 1215 associated with the team, a secondary question 1220, and the tertiary questions 1221-1224 associated with the second question 1220. The questioning module 305 may also provide the one or more predefined responses corresponding to the main, primary, secondary, and/or tertiary questions respectively. For example, the questioning module 305 may provide the predefined responses 1224-1 and 1224-2 corresponding to the tertiary question(s) related to the design presence 1224. Furthermore, the questioning module 305 may provide one or more questions related to the timelines 1300 of the project(s) and the predefined responses 1305-1325 as shown in FIG. 13, and the questions related to the sponsorship 1400 associated with the project(s) and the predefined responses 1405 and 1410 as shown in FIG. 14. In an embodiment, the questioning module 305 may provide the questions and the predefined responses and receive the responses and/or the selected responses via an interactive application such as, but not limited to, a stand-alone chat application or a web chat application, stored in and/or provided in the user device 110 (see FIG. 2).

Referring again to FIGS. 2-3, the user may then select the appropriate response from the predefined responses corresponding to the main, primary, secondary, and/or tertiary questions using the user device 110 and provide the selected responses to the recommendation system 105 via the network 130.

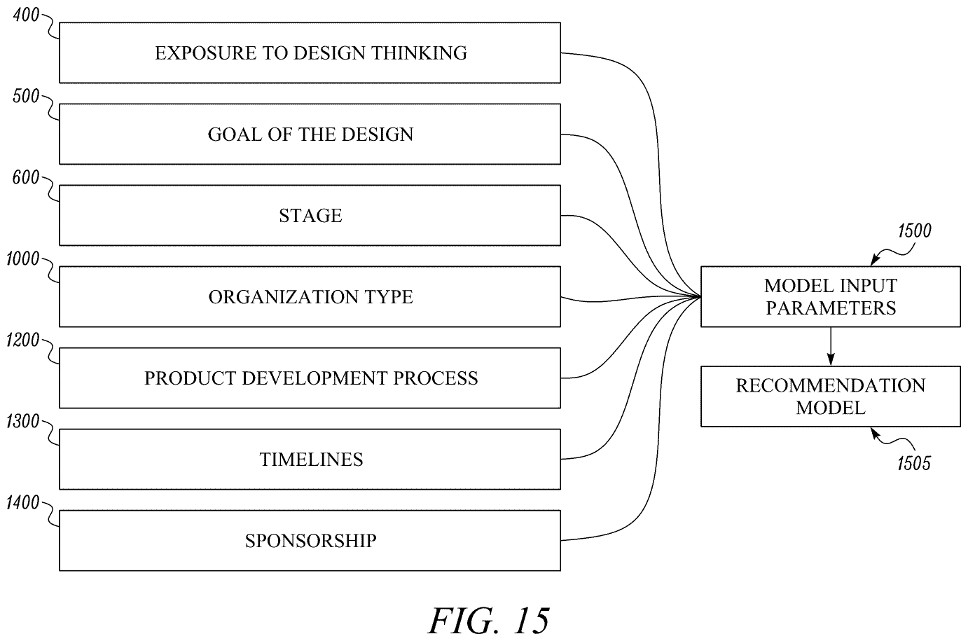

The parameters module 310 may further comprise an analyzing module 311 and a determination module 312. The analyzing module 311 may receive one or more responses corresponding to the questions respectively from the user device 110 via the network 130. In an embodiment, the analyzing module 311 may receive the selected responses from the predefined responses provided corresponding to the questions from the user device 110, for example, as shown in FIGS. 4-14. In an embodiment, the analyzing module 311 may determine one or more input values corresponding to the predefined input parameters 1500 for a recommendation model 1505, as shown in FIG. 15, by analyzing the responses received from the user device 110 corresponding to the questions related to the exposure 400 to design thinking, the goal 500 of the project(s), the execution stage 600 of the project(s), the organization type 1000, the product development process 1200, the project timelines 1300, and/or the sponsorships 1400. In some embodiments, the analyzing module 311 may apply one or more natural language processing (NLP) machine learning models provided in the recommendation model 1505 to the responses received to identify one or more keywords used in the responses and determine the input values based on the keywords identified. Examples of the predefined input parameters include, but are not limited to, the level of user understanding of the design thinking concepts, techniques, and/or methodologies, the goal of the project(s) or the tasks, the execution stage of the project or the tasks, the timelines associated with the project(s) or the tasks, the ownership type, the size, the structure, the industry, and the customer segment associated with the entity, the team members involved in the project(s) or the tasks, the number of team members involved, the development processes, and/or the sponsorship. In an embodiment, the analyzing module 311 may also assign a ranking and/or a score corresponding to one or more predefined input parameters 1500 based on the input values determined, for example, the analyzing module 311 may assign a score corresponding to the level of user understanding of the design thinking concepts, techniques, and/or methodologies, and/or the goal of the project(s) or the tasks. The analyzing module 311 may then compare the input values determined corresponding to the predefined input parameters with the predefined input values provided corresponding to the predefined input parameters. In an embodiment, the predefined input values provided are associated with the predefined projects and/or the predefined entities stored in the storage unit 225. In some embodiments, analyzing module 311 may also compare the responses received with the predefined responses provided corresponding to the questions and/or the predefined questions stored in the storage unit 225. In an embodiment, the predefined responses may be associated with the predefined projects and/or the predefined entities. In an embodiment, the analyzing module 311 may identify one or more similarities between the responses received and the predefined responses and/or the similarities between the input values determined and/or the predefined input values. The analyzing module 311 may then identify one or more peers associated with the project(s) and/or the entity based on the comparison and/or the similarities identified. In an embodiment, the peers may comprise, but are not limited to, one or more peer projects identified among the predefined projects and/or one or more peer entities identified among the predefined entities. In an embodiment, the analyzing module 311 may apply one or more machine learning models (k-NN model(s)) provided in the recommendation model 1505 (see FIG. 15) that implement a k nearest neighbor (k-NN) algorithm to identify the peers. The k-NN algorithm is a non-parametric, supervised learning classifier, which uses proximity to make classifications, regressions, or predictions about a grouping of an individual object or data point. The individual data point may correspond to the project(s), the tasks, and/or the entity. An output of k-NN classification is a class membership. The object or the data point is classified by a plurality vote of k nearest neighbors identified corresponding to the object. The k-NN algorithm then assigns the object to a class common among the k nearest neighbors identified where k is a positive integer. The k nearest neighbors may correspond to the predefined responses, the predefined input values, the predefined input parameters, the predefined projects, the predefined tasks, and/or the predefined entities. For instances when k=1, then the object is assigned to the class of a single nearest neighbor. An output of k-NN regression is a property value for the object. The property value is an average of the property values of the k nearest neighbors. For example, the k-NN classification or regression algorithm can be applied to the responses received and/or input values determined corresponding to the predefined input parameters 1500 (see FIG. 15) to identify the peers from the predefined projects, the predefined tasks, and/or the predefined entities based on the comparison and/or the similarities identified. In some embodiments, the analyzing module 311 may implement a machine learning model provided in the recommendation model 1505 that uses a combination of the k-NN classification and the k-NN regression to identify the peers.

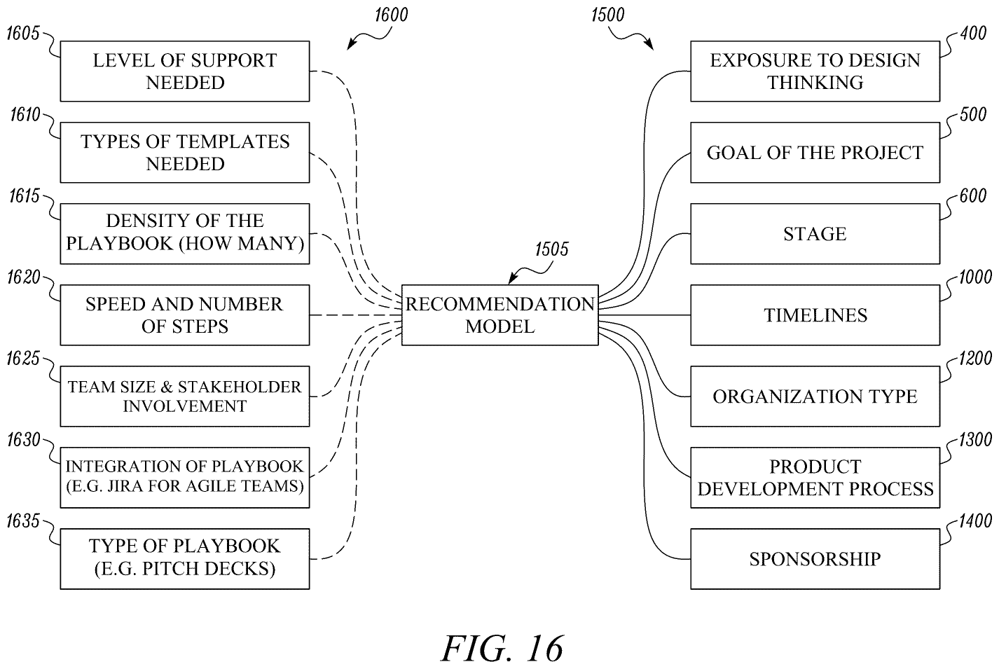

The determination module 312 may determine one or more output values, as shown in FIG. 16, corresponding to the predefined output parameters 1600 of the recommendation model 1505 based on the identification of the peers. The predefined output parameters 1600 may be associated with the design thinking framework(s). Referring to FIG. 16, examples of the predefined output parameters 1600 may comprise, but are not limited to, a level of support 1605 needed for the project(s), one or more types of one or more design thinking process plans or templates 1610 needed, a density or number 1615 of the design thinking process plans/templates/playbook of each type of the design thinking process plans/templates needed respectively, a number of one or more process steps and an execution time or speed 1620 corresponding to each process step of the process steps required in the design thinking process plans/templates of each type, a number of one or more team members or team size/stakeholder involvement 1625 required to execute the project(s) or the tasks and/or a role of each team member, a file format or integration 1630 of the design thinking process plans/templates/playbook to be generated for the third-party applications like Jira™ used by Agile teams, and/or a type or format 1635 of the design thinking framework/playbook to be generated. In an embodiment, the determination module 312 may determine the output values by analyzing the responses received from the user device 110 and/or the input values determined corresponding to the questions related to the exposure 400 to design thinking, the goal 500 of the project(s), the execution stage 600 of the project(s), the organization type 1000, the product development process 1200, the project timelines 1300, and/or the sponsorships 1400.

Referring again to FIGS. 2-3, in some embodiments, the determination module 312 may also determine the output values based on the predefined output values provided corresponding to the predefined output parameters for the peers identified comprising the predefined peer projects and/or peer entities. In some embodiments, the output values determined corresponding to the predefined output parameters 1600 by the determination module 312 may be similar to or different from the predefined output values provided corresponding to the predefined output parameters for the peers identified comprising the predefined peer projects and/or peer entities. In an embodiment, the determination module 312 may also assign a dynamic weightage to the output values determined corresponding to the predefined output parameters 1600 based on the one or more factors. Examples of the factors comprise, but are not limited to, priority, order, timeline, the number of team members, and/or the type of team(s) assigned to the project(s) or the tasks.

The framework generation module 315 may generate one or more design thinking framework(s) using the recommendation model 1505 (see FIG. 15) based on the output values determined. The design thinking framework(s) generated comprises, but is not limited to, one or more design thinking related process plans, diagrams, project plans, team composition plans, schedule of project/task timelines, framework usage guidelines, presentations, and/or templates to guide cross-functional project owners such as, but not limited to, business partners, product managers, UX designers, and technology teams to incorporate and/or implement the design thinking framework(s) in the project(s). In an embodiment, the framework generation module 315 may generate a projected schedule of project/task timelines in the design thinking framework(s) based on past/historic project completion trends stored in the storage unit 225. In an embodiment, the design thinking framework(s) may also comprise one or more guided steps associated with one or more requirements associated with the project(s) such as, but not limited to, customer interview guides, survey templates, current state workflow maps to identify gaps in current state of the project(s), target state user experience flows, end-to-end service blueprints to map front-stage design systems visible to customers and/or back-stage design systems that are not visible to customers, responsible, accountable, consulted, and informed (RACI) charts to outline team member tasks, new product opportunity mapping, customer profile mapping, project task timelines, feedback gathering mechanisms, Quality Assurance testing guides, user interface design systems, value proposition statement generators, and/or ideation workshop frameworks. In an embodiment, the framework generation module 315 may determine the project requirements to be incorporated in the design thinking framework(s) based on the analysis of the responses received by the analyzing module 311 and/or the input values determined by the determination module 312. In an embodiment, the framework generation module 315 may also incorporate the input values determined corresponding to one or predefined input parameters in the generated design thinking framework(s). For example, the framework generation module 315 may incorporate the input values determined corresponding to the goal 400 of the project(s) or the tasks, the execution stage 600 of the project or the tasks, the timelines 1000 associated with the project(s) or the tasks, the team 1100 (see FIG. 11) or team composition comprising the team members and the number of team members involved 1100 in the project(s) or the tasks as shown in FIG. 16. In an embodiment, framework generation module 315 may also generate the design thinking framework(s) comprising newly generated data such as, but not limited to, new tasks and/or subtasks for the project, new goals of the project(s) and/or the new tasks/sub-tasks, new stages for each new goal of project and/or the new tasks/sub-tasks, new projected execution timelines associated with the new stages, the project(s), and/or the new tasks/sub-tasks, new team(s) and/or team compositions comprising new team members and a number of the new team members required in the project(s) and/or the new tasks/sub-tasks. The framework generation module 315 may generate the design thinking framework(s) comprising the newly generated data based on, but not limited to, the responses received, the input values determined, the predefined responses, the output values, and/or the predefined design thinking framework(s) associated with the predefined projects and/or entities using one or more AI models provided in the recommendation model 1505 (see FIG. 15). In an embodiment, framework generation module 315 may also generate one or more graphical representations of the input values incorporated and/or the newly generated data and incorporate the graphical representations in the design thinking framework(s).

In an embodiment, the guided steps provided in the design thinking framework(s) may also provide instructions on when and/or how to use and/or implement the design thinking framework(s), seek consultative support from designers world-wide, and/or hire a full-time design team to implement the design thinking framework generated for the project(s) and for the project completion. In an embodiment, framework generation module 315 may incorporate a virtual support system in the design thinking frameworks generated to provide the guided steps. In some embodiments, framework generation module 315 may incorporate the virtual support provided by third-party services. The virtual support system may comprise, but is not limited to, a virtual assistant for text, audio, and/or video interaction with a user implemented by one or more machine learning and/or AI models provided by the recommendation model 1505 (see FIG. 5) or by the third-party services. In an embodiment, the design thinking framework(s) generated may also comprise, but is not limited to, one or more visual and/or graphical elements, and/or text, audio, and/or video content. The framework generation module 315 may also generate one or more types of the design thinking framework(s). Examples of the types or formats of the design thinking framework(s) comprise but are not limited to, design thinking digital manuals, flipbooks with graphical illustrations, short-form playbooks, long-form word documents and/or narratives, deck or formal presentations, spreadsheet-based project plans, graphical print posters, and/or audio books. In an embodiment, the framework generation module 315 may incorporate the design thinking process plans and/or templates in each type of the design thinking framework generated. In an embodiment, the framework generation module 315 may also generate the design thinking frameworks in one or more content formats. In some embodiments, the framework generation module 315 may also generate the design thinking frameworks in one or more downloadable digital file formats that are compatible with one or more native, system, and/or third-party applications provided in the user device 110 (see FIGS. 1-2) respectively. Examples of the downloadable digital file formats comprise, but not limited to, Word document (DOC and DOCX), Microsoft® PowerPoint Presentation (PPT or PPTX), Apple® Keynote File (KEY), Portable Document Format (PDF), Graphics interchange format (GIF), Portable networks graphic (PNG), Joint photographic experts' group (JPEG or JPG), Hypertext markup language (HTML), Audio files (MP4), and Text file (TXT). In some embodiments, the framework generation module 315 may also generate the design thinking frameworks in the digital file formats that are compatible with and can be integrated with applications such as, but not limited to, Signavio™, Adobe™, Jira™, Figma™, and Confluence™. In some embodiments, the framework generation module 315 may also generate the design thinking framework(s) in an executable format or as an executable file such that the design thinking framework(s) generated may be accessed in a stand-alone application that is provided upon execution of the executable file in the user device 110. In an embodiment, the framework generation module 315 may include one or more design thinking frameworks generated in a single executable file. In some embodiments, the framework generation module 315 may also generate the design thinking framework(s) as a web application such that the design thinking framework(s) generated may be accessed by the user device 110 via the network 130 or the Internet. In an embodiment, the recommendation model 1505 (see FIG. 15) may dynamically learn from the responses received and/or the input values determined using the AI models provided in the recommendation model 1505 and enable the framework generation module 315 to generate new design thinking framework(s) that are different from the predefined design thinking framework(s) comprising, but not limited to, the predefined design thinking process plans, templates, and/or other design thinking framework related resources stored in the storage unit 225. In an embodiment, the framework generation module 315 may also store the design thinking framework(s) generated in the different content formats, the downloadable digital file formats, the executable file formats, and/or as the web application in the storage unit 225.

The delivery module 320 may provide the design thinking framework(s) generated to the user device 110 via the network 130. In an embodiment, the delivery module 320 may provide the design thinking framework(s) in one or more content formats, the downloadable digital file formats, the executable file formats, and/or as the web application. In some embodiments, the design thinking framework(s) provided to the user device 110 may be editable to facilitate edits to one or more contents provided in the design thinking framework(s), modifiable to facilitate modifications to visual, graphical, and/or design aspects provided in the design thinking framework(s), and/or alterable to facilitate altering a structure or order of the contents in the design thinking framework(s). In an embodiment, the design thinking framework(s) provided to the user device 110 may be editable, modifiable, and/or alterable by the user via one or more input devices provided in the user device 110. In an embodiment, the delivery module 320 may provide the design thinking framework(s) via the interactive application stored in and/or provided in the user device 110. In an embodiment, the delivery module 320 may also be configured to modify and provide the modified design thinking framework(s) to the user device 110 based on the account information such as, but not limited to, the user preferences, stored in the storage unit 225.

In some embodiments, the user device 110 may enable the user to incorporate and access the design thinking framework(s) in the native, system, and/or third-party applications. In some embodiments, the user device 110 may also execute the executable file format of the design thinking framework(s) generated to provide the stand-alone application which provides access to the design thinking framework(s) generated. In some embodiments, the user device 110 may also access the design thinking framework(s) via the web application accessible to the user via a browser and the Internet or the network 130. In such embodiments, the recommendation system 105 may receive a request from the user device 110 via the network 130 to access the web application and the recommendation system 105 may execute the web application stored in the storage unit 225 to provide the design thinking framework(s) generated via the web application on the browser provided in the user device 110. In an embodiment, the user may interact with and/or use the design thinking frameworks provided in the user device 110. In some embodiments, the user may seek help from the virtual support or assistant provided in the design thinking frameworks. The virtual assistant may enable a user to raise inquiries to the recommendation system 105, provide answers to frequently asked questions (FAQs), and/or provide advisory support to avail consultative services with specialized topics such as design thinking process or for specific training sessions on running, executing, and/or implementing the design thinking framework(s). The virtual assistant may also enable a user to avail a managed service to provide a complete staffing solution with teams. In some embodiments, the usage and/or the interaction of the user with the design thinking frameworks may also be tracked and/or monitored by one or more tracking applications and/or the native, system, and/or third-party applications provided in the user device 110. Examples of the tracking applications comprise, but are not limited to, Adobe™ Analytics and Matomo™. In some embodiments, the user device 110 may also retrieve design related data corresponding to one or more UX designs associated with one or more applications and/or platforms provided in the native, system, and/or third-party applications. The user device 110 may also retrieve usage data corresponding to the usage and/or the interaction. In an embodiment, the user device 110 may also retrieve the design related data and/or the usage data intermittently after a predefined time period. The design related data may comprise data related to the UX designs such as, but not limited to, instances of user interfaces created in the native, system, and/or third-party applications, or created directly in a Quality Assurance (QA Test) environment, and/or data related to design elements such as, but not limited to, buttons, image sizes, and text sizes included in user interfaces. The usage data may comprise, but is not limited to, time spent using the design thinking framework(s), one or more portions of the design thinking framework(s) indicating longer interaction or used more frequently than other portions of the design thinking framework(s), the type of the design thinking framework(s) used more frequently than other types of the design thinking framework(s), and/or impact of the design thinking framework(s) on efficiency parameters such as, but not limited to, operational costs and/or revenue generated. In such embodiments, the user device 110 may be configured to retrieve and consolidate the design related data and/or usage data from the tracking applications and/or the native, system, and/or third-party applications and provide the design related data and/or the usage data to the recommendation system 105 via the network 130. In embodiments in which the design thinking framework(s) may be provided as a web application accessible via the browser provided in the user device 110, the web application may be configured to track, monitor, obtain, and store the design related data and/or the usage data as the user interacts with the design thinking framework(s) via the browser in the user device 110. In some embodiments, the user device 110 may also enable the user to provide feedback associated with the design thinking framework(s) to the recommendation system 105 via the user device 110. In an embodiment, the user device 110 may also receive the feedback from the user via the native, system, and/or third-party applications. In some embodiments, the user may also provide the feedback directly to the recommendation system 105 via the web application accessed via the browser provided in the user device 110. In some embodiments, the user device 110 may provide the feedback along with design related data and/or the usage data to the recommendation system 105 via the network 130.

The feedback module 325 may retrieve or receive the feedback, the design related data and/or the usage data associated with the design thinking framework from the user device 110 via the network 130 or directly via the web application provided to the user device 110. In an embodiment, the feedback module 325 may be configured to assign and/or calculate engagement scores based on the feedback and/or the usage data received and/or retrieved. The feedback module 325 may also be configured to determine and provide insights based on the feedback and/or the usage data via the display 230. The feedback module 325 may also be configured to ensure that the user interfaces associated with the UX designs are similar and/or consistent in design aspects with respect to each other across the application(s), and/or the platforms based on the design related data. The feedback module 325 may be configured to monitor the instances of the user interface(s) created based on the design related data received and/or retrieved, and/or identify inconsistencies found in the user interface(s). The feedback module 325 may also be configured to provide an option on the user device 110 for the user to provide a preferred instance of the user interface(s) and implement the preferred instance across the application(s) and/or the platforms and/or in the UX designs created in the native, system, and/or third-party applications in the user device 110. The feedback module 325 may also be configured to catalog one or more versions of the preferred instances received in the design thinking framework(s) that the user will be able to track and/or view the versions via the user device 110 and the network 130. In an embodiment, the feedback module 325 may also be configured to determine a quality, relevance, and/or effectiveness of the design thinking frameworks provided based on the usage data. In an embodiment, the feedback module 325 may also be configured to train the recommendation model 1505 (see FIG. 15) based on the feedback, the design related data and/or the usage data. In an embodiment, the feedback module 325 may be configured to modify the determined input and/or output values and/or the predefined input and/or output parameters associated with the recommendation model 1505 based on the feedback and/or the usage data to train the recommendation model 1505. In an embodiment, the feedback module 325 may be configured to update the trained recommendation model 1505 based on the training and store the trained and updated recommendation model 1505 in the storage unit 225. The feedback module 325 may also be configured to generate new design thinking framework(s) that are different from the design thinking framework(s) generated by the framework generation module 315 and/or modify the design thinking framework(s) generated by the framework generation module 315 based on the feedback, the usage data, and/or the trained and/or updated recommendation model 1505. The feedback module 325 may also be configured to provide the modified design thinking framework(s) to the user device 110 via the network 130. In an embodiment, the feedback module 325 may also be configured to update the account information related to the user and/or entity and store the updated account information based on the feedback received and/or the usage data. In some embodiments, the feedback module 325 may also be configured to generate and provide the modified design thinking framework(s) to the user device 110 based on the updated account information.

### INDUSTRIAL APPLICABILITY

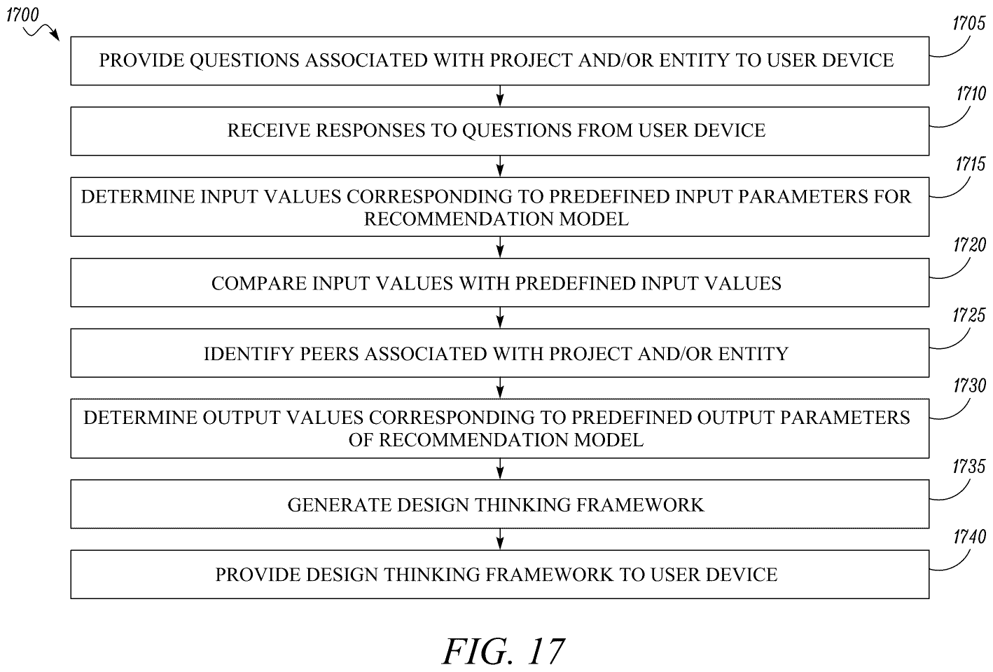

Referring to FIG. 17, an exemplary method 1700 for incorporating one or more design thinking frameworks in a project using the recommendation system 105 of FIGS. 1-2 is disclosed. The method 1700 comprises a step 1705 of providing, via the processor 210 of the recommendation system 105, one or more questions associated with the project(s) and/or an entity associated with the project(s) to the user device 110 of FIG. 1 via the network 130 of FIG. 1. The method 1700 also comprises a step 1710 of receiving, via the processor 210, one or more responses corresponding to the questions from the user device 110 via the network. Further, the method 1700 comprises a step of 1715 of determining, via the processor 210, one or more input values corresponding to one or more predefined input parameters 1500 (see FIG. 5) for the recommendation model 1505 (see FIG. 15) based on the responses. The method 1700 also comprises a step 1720 of comparing, via the processor 210, the input values corresponding to the predefined input parameters 1500 determined with one or more predefined inputs provided corresponding to one or more predefined parameters. The predefined inputs provided may be associated with one or more predefined projects and/or one or more predefined entities. In addition, the method 1700 comprises a step 1725 of identifying, via the processor 210, one or more peers associated with project(s) and/or the entity based on the comparison using the recommendation model 1505. The peers comprise one or more peer projects identified among the predefined projects and/or one or more peer entities identified among the predefined entities. The method 1700 also comprises a step 1730 of determining, via the processor 210, one or more output values corresponding to one or more predefined output parameters of the recommendation model 1505 based on the identification. The predefined output parameters 1600 (see FIG. 16) are associated with the design thinking framework(s). Furthermore, the method 1700 comprises a step 1735 of generating, via the processor 210, the design thinking frameworks based on the output values determined corresponding to the predefined output parameters 1600. The method 1700 also comprises a step 1740 of providing, via the processor 210, the design thinking frameworks to the user device 110 via the network 130.

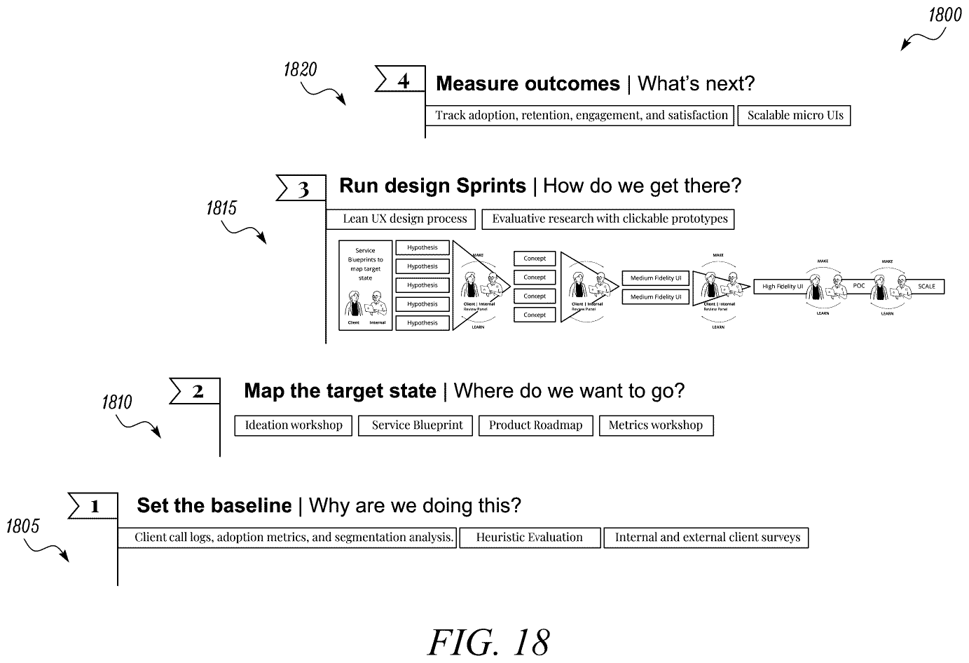

Referring to FIG. 18, an exemplary illustration of a design thinking framework 1800 generated based on responses to questions received from a user via the user device 110 of FIG. 1 and provided to the user device 110 by the recommendation system 105 of FIG. 1 is disclosed. The design thinking framework 1800 may comprise a design thinking process plan comprising guided steps 1805-1820 for product development.

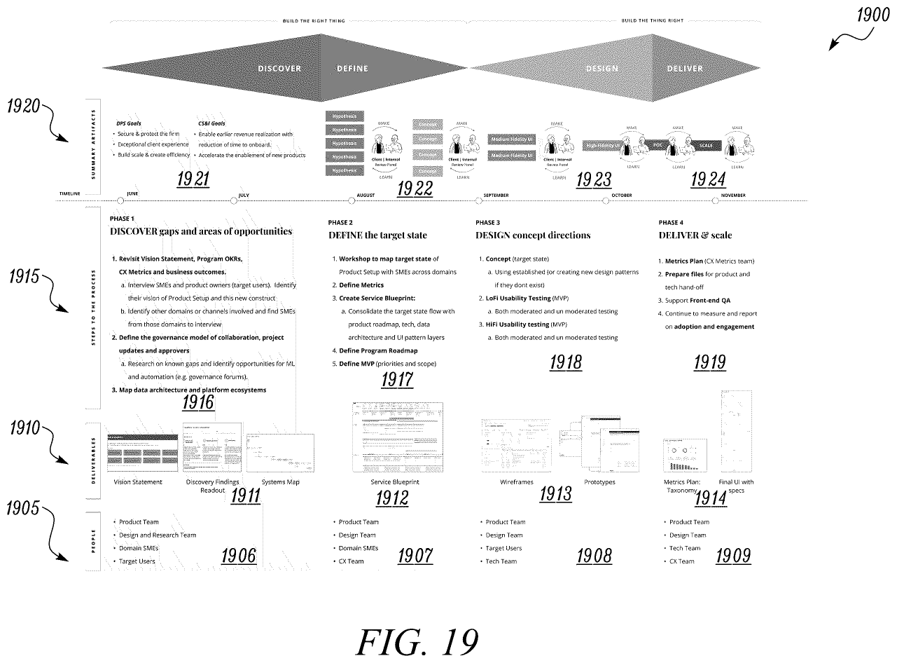

Referring to FIG. 19, another exemplary illustration of a design thinking framework 1900 generated based on responses to questions received from a user via the user device 110 of FIG. 1 and provided to the user device 110 by the recommendation system 105 of FIG. 1 is disclosed. The design thinking framework 1900 may comprise a design thinking process plan comprising multiple guided steps 1906-1909, 1911-1914, 1916-1919, 1921-1924 corresponding to multiple output parameters 1905, 1910, 1915, and 1920 respectively as identified and generated by the recommendation system 105 in the design thinking framework 1900 for product development.

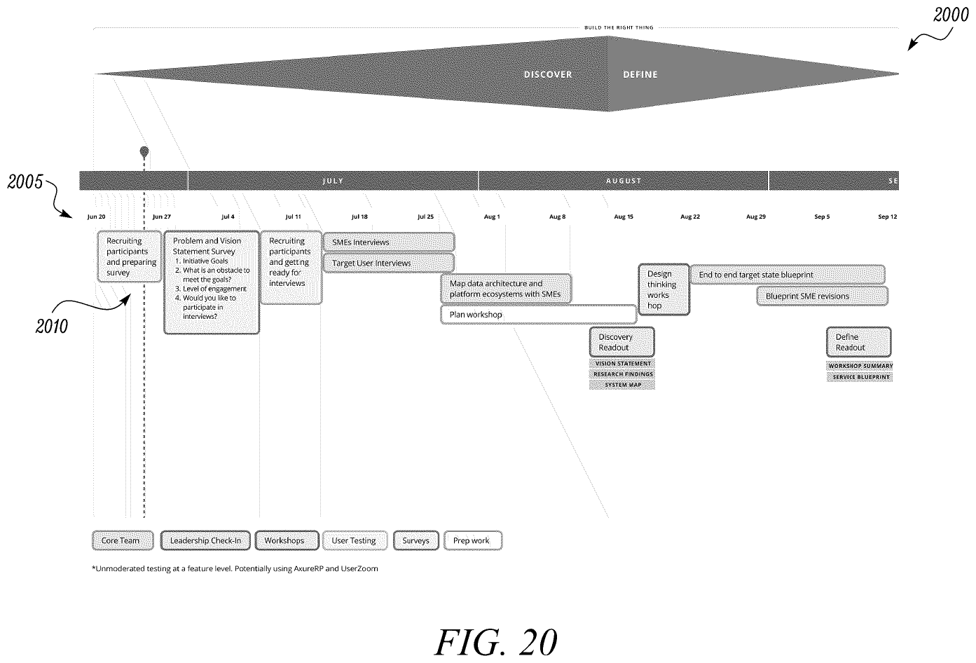

Referring to FIG. 20, yet another exemplary illustration of a design thinking framework 2000 generated based on responses to questions received from a user via the user device 110 of FIG. 1 and provided to the user device 110 by the recommendation system 105 of FIG. 1 is disclosed. The design thinking framework 2000 may comprise a design thinking process plan comprising project timelines 2005 and different tasks 2010 of the project to be executed for each timeline as identified and generated by the recommendation system 105 in the design thinking framework 2000 for product development.

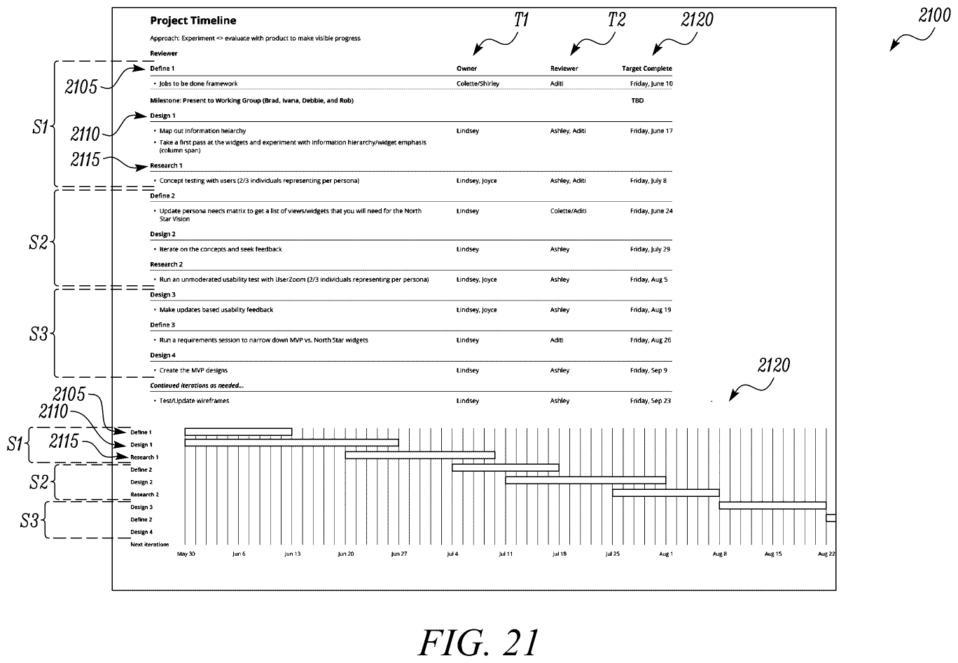

Referring to FIG. 21, yet another exemplary illustration of a design thinking framework 2100 generated based on responses to questions received from a user via the user device 110 of FIG. 1 and provided to the user device 110 by the recommendation system 105 of FIG. 1 is disclosed. The design thinking framework 2100 may comprise a design thinking process plan comprising different tasks 2105-2115 for different stages S1, S2, S3 of a project respectively, different timelines 2120 for each task in each stage, and team members T1, T2 involved for each task in each stage as identified and/or generated by the recommendation system 105 in the design thinking framework 2100 for product development.

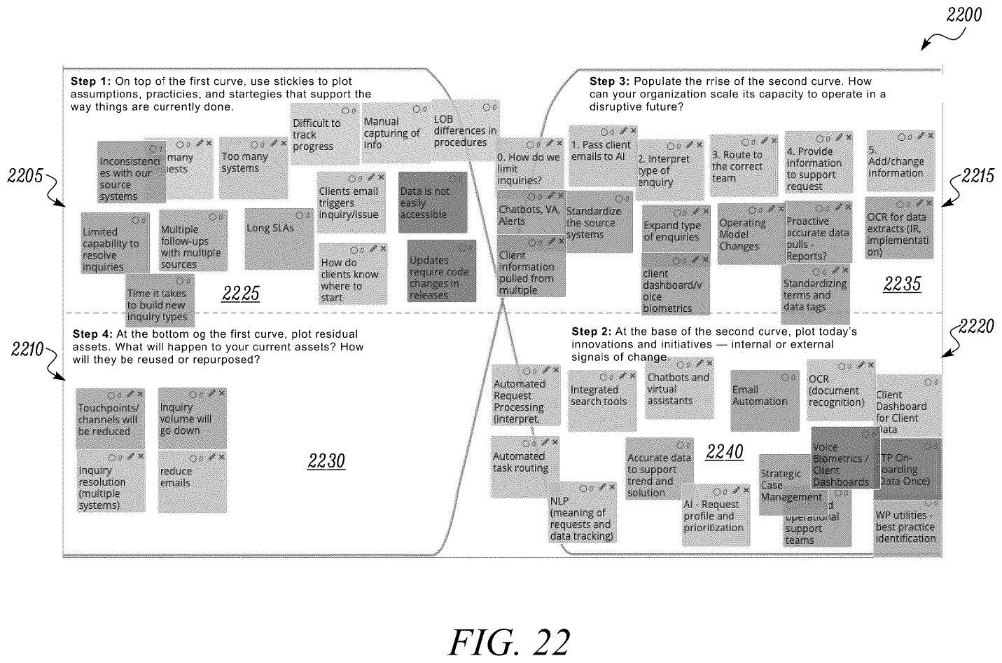

Referring to FIG. 22, yet another exemplary illustration of a design thinking framework 2200 generated based on responses to questions received from a user via the user device 110 of FIG. 1 and provided to the user device 110 by the recommendation system 105 of FIG. 1 is disclosed. The design thinking framework 2200 may comprise a design thinking template for a vision setting workshop project comprising actionable guided steps 2205-2220 identified and/or generated for the project meeting by the recommendation system 105 in the design thinking framework 2200 for product development. The design thinking framework 2200 also comprises input portions 2225-2240 to edit and/or include one or more actions taken corresponding to the actionable guided steps 2105-2120 respectively.

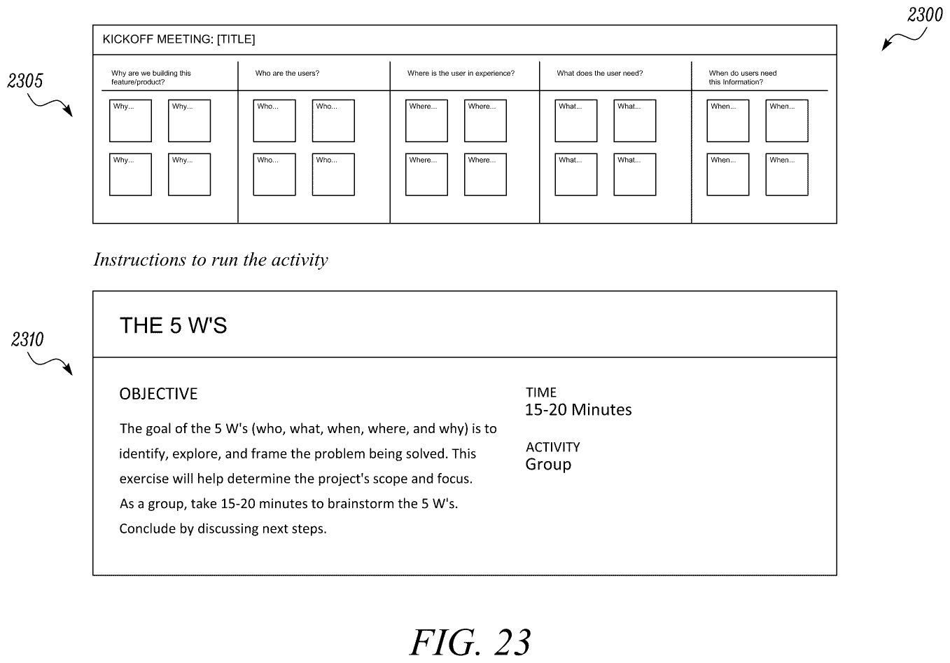

Referring to FIG. 23, yet another exemplary illustration of a design thinking framework 2300 generated based on responses to questions received from a user via the user device 110 of FIG. 1 and provided to the user device 110 by the recommendation system 105 of FIG. 1 is disclosed. The design thinking framework 2300 may comprise a design thinking template for a project meeting comprising one or more agendas 2305 and guided steps 2310 to be implemented for each agenda identified and/or generated for the project meeting by the recommendation system 105 in the design thinking framework 2300 for product development.

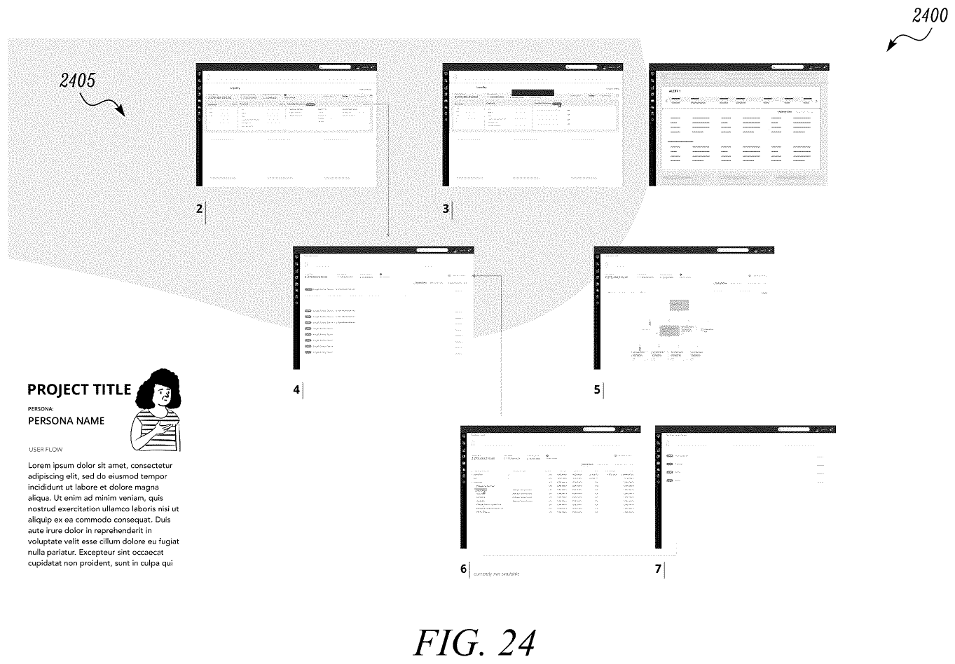

Referring to FIG. 24, yet another exemplary illustration of a design thinking framework 2400 generated based on responses to questions received from a user via the user device 110 of FIG. 1 and provided to the user device 110 by the recommendation system 105 of FIG. 1 is disclosed. The design thinking framework 2400 may comprise a graphical flow diagram of a series of user interfaces 2405 such as, but not limited to, web pages or web page designs identified and/or generated by the recommendation system 105 in the design thinking framework 2400.

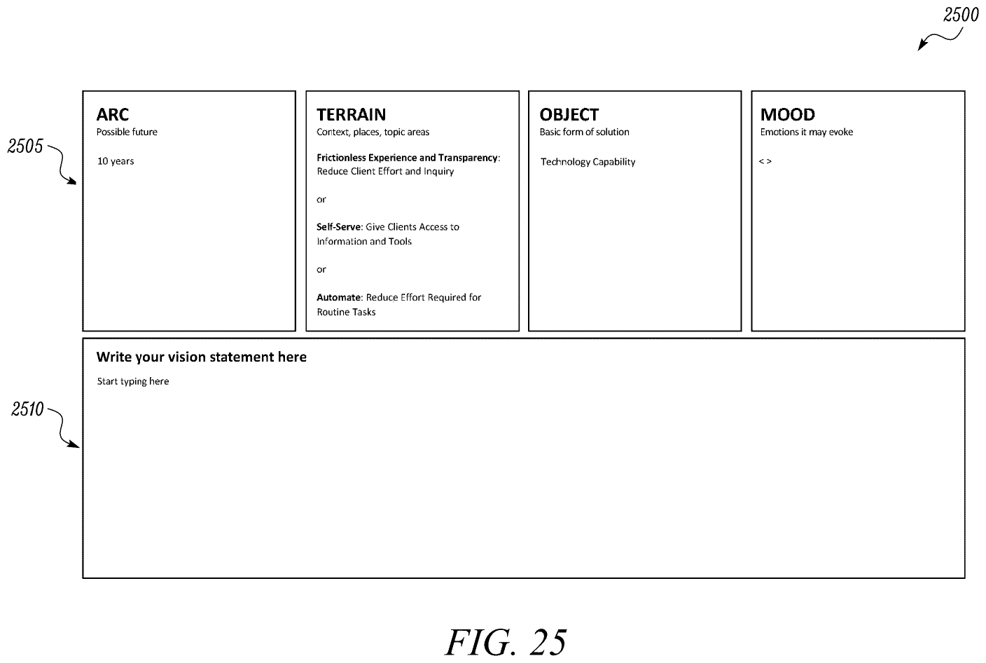

Referring to FIG. 25, an exemplary illustration of a design thinking framework 2500 generated based on responses to questions received from a user via the user device 110 of FIG. 1 and provided to the user device 110 by the recommendation system 105 of FIG. 1 is disclosed. The design thinking framework 2500 may comprise a design thinking template comprising one or more aspects 2505 associated with a vision for an entity as identified and/or generated by the recommendation system 105 in the design thinking framework 2500 and one or more input portions or regions 2510 in the design thinking process plan/template to determine and provide a vision statement for the entity based on the aspects 2505.

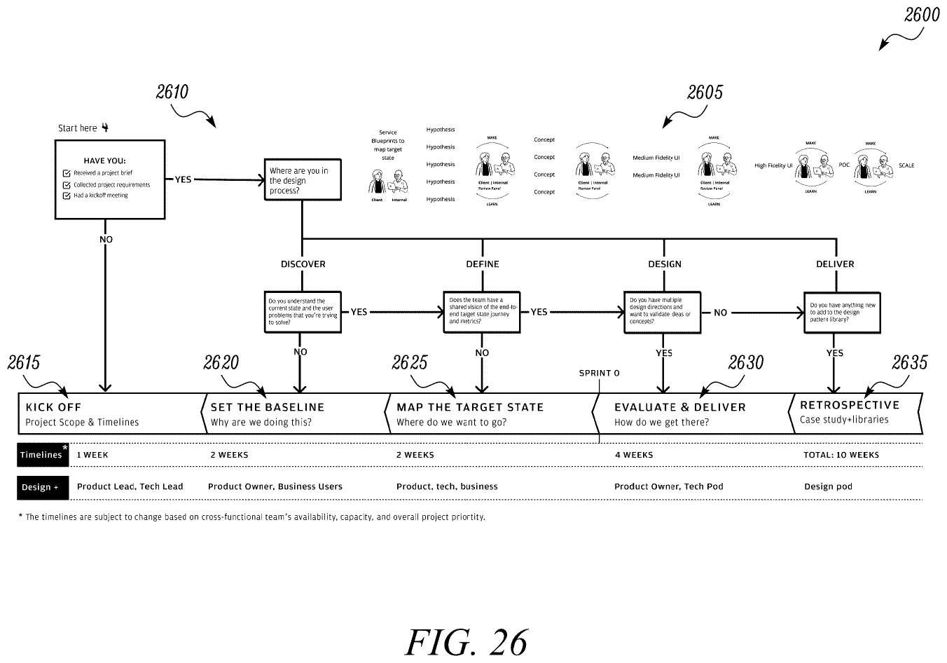

Referring to FIG. 26, an exemplary illustration of a design thinking framework 2600 generated based on responses to questions received from a user via the user device 110 of FIG. 1 and provided to the user device 110 by the recommendation system 105 of FIG. 1 is disclosed. The design thinking framework 2600 may comprise a graphical flow diagram comprising graphical design thinking process illustrations 2605 and a flow chart 2610 to determine how and when tasks 2615-2635 are be performed as identified and/or generated by the recommendation system 105 in the design thinking framework 2600 for product development.

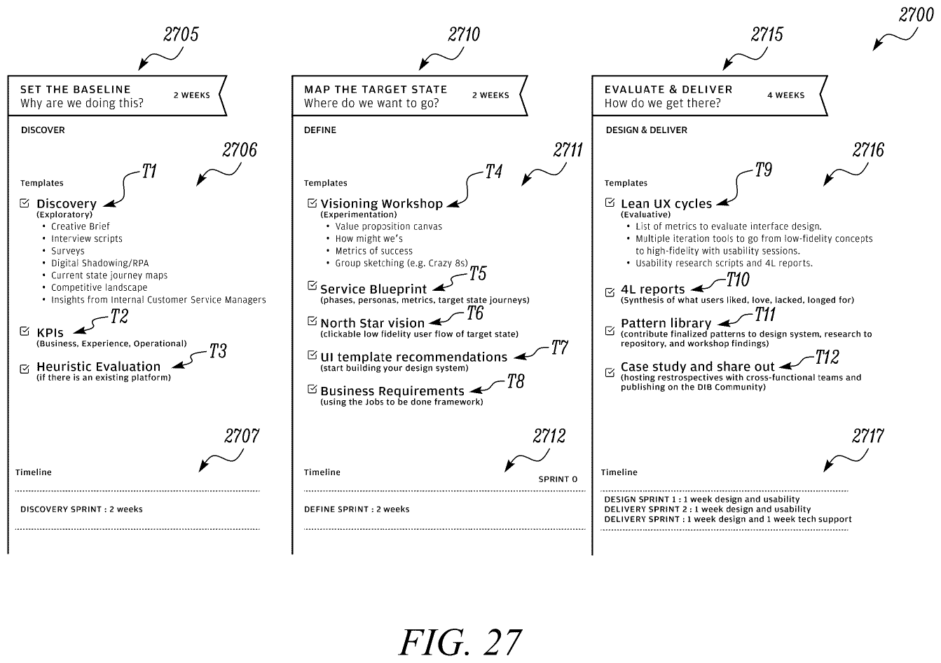

Referring to FIG. 27, an exemplary illustration of a design thinking framework 2700 generated based on responses to questions received from a user via the user device 110 of FIG. 1 and provided to the user device 110 by the recommendation system 105 of FIG. 1 is disclosed. The design thinking framework 2700 may comprise a design thinking process plan comprising tasks 2705-2715, one or more design thinking templates 2706, 2711, 2716 for different sub-tasks T1-T12 respectively in each task to be included, considered, and/or implemented for the tasks 2705-2715 respectively, and timelines 2707, 2712, 2717 for each task as identified and/or generated by the recommendation system 105 in the design thinking framework 2700 for product development.

It is apparent, in view of the above, that the recommendation system 105 and the method 1700 of the present disclosure enable a user and/or an entity to incorporate one or more design thinking frameworks in one or more projects and ensure improved digital adoption of the project(s) by customers of the user and/or the entity and also ensure improved customer satisfaction by reducing development risks arising due to lack of the design thinking know-how and/or resources. Typically, product development and technology teams face difficulties in adopting and/or facilitating the design thinking concepts, techniques, and/or methodologies independently in projects. This is because the design thinking frameworks are created with help from dedicated user experience design teams in a centralized (having a group of designers) or a decentralized team model (with the product and technology teams). The recommendation system 105 and the method 1700 of the present disclosure solve such difficulties and automate generation, use, and/or implementation of the design thinking frameworks in the project(s) by providing the design thinking frameworks that are compatible with and can be incorporated with preferred native, system, and/or third-party application(s) defined by the user, entity, and/or the product and technology teams. The recommendation system 105 and the method 1700 of the present disclosure also address such difficulties by providing guided steps on when and how to facilitate and/or implement the design thinking frameworks for different projects such as product development and by providing timeline tracking for different tasks of the project(s) identified in the design thinking frameworks. Thus, it is apparent that the recommendation system 105 and the method 1700 of the present disclosure may provide business benefits to the user and/or entities associated with different domains and/or industries as a result of facilitating the incorporation of the design thinking frameworks in various projects. Further, the recommendation system 105 and the method 1700 of the present disclosure enable the users/entity/teams to adopt the design thinking frameworks with minimal support and create usable, valuable, ethical, and functionally and/or aesthetically desirable products/services based on the design thinking frameworks. The recommendation system 105 and the method 1700 of the present disclosure will also solve for setting up a customer-centric product innovation process at an organization based on the design thinking framework(s) with minimal and/or no specialized support. The recommendation system 105 and the method 1700 of the present disclosure will also help in implementing updated design thinking frameworks by tracking and/or monitoring daily reports comprising design and/or usage related data associated with usage/implementation of the design thinking frameworks, by tracking an impact of implementing the design thinking frameworks in terms of project costs savings and/or project revenue generated, and by providing virtual support to offer additional help with the design thinking frameworks. Furthermore, typically, the entities invest significant time, effort, and monetary resources in hiring design agencies to create and/or implement the design thinking frameworks in various projects associated with the entity. The recommendation system 105 and the method 1700 of the present disclosure will help address such problems by providing the design thinking frameworks that can accessed and/or implemented with minimal effort and/or without specialized support of the design agencies, thereby providing cost benefits. In addition, conventional design thinking frameworks are typically difficult to use without guided steps which leads to entities abandoning design thinking initiatives for the project(s). The recommendation system 105 and the method 1700 of the present disclosure will help address such problems by providing practical ways with the guided steps to implement the design thinking frameworks, and by providing interactive content in the design thinking frameworks for preparation and/or facilitation of the design thinking frameworks in the project(s).

It will be apparent to those skilled in the art that various modifications and variations can be made to the system of the present disclosure without departing from the scope of the disclosure. Other embodiments will be apparent to those skilled in the art from consideration of the specification and practice of the system disclosed herein. It is intended that the specification and examples be considered as exemplary only, with a true scope of the disclosure being indicated by the following claims and their equivalent.

We claim:

1. A recommendation system for incorporating one or more design thinking frameworks in a project, comprising:
a memory to store instructions;
a processor configured to execute the instructions stored in the memory to perform one or more functions comprising:
providing one or more questions associated with the project, an entity associated with the project, or both the project and the entity to a user device via a network;
receiving one or more responses corresponding to the one or more questions from the user device via the network;
determining one or more input values corresponding to one or more predefined input parameters for a model based on the one or more responses;
comparing the one or more input values with one or more predefined input values provided corresponding to the one or more predefined input parameters respectively, wherein the one or more predefined input values provided are associated with one or more predefined projects, one or more predefined entities, or both the one or more predefined projects and the one or more predefined entities;
identifying one or more peers associated with project, the entity, or both the project and the entity based on the comparison using the model, wherein the one or more peers comprise at least one of one or more peer projects identified among the one or more predefined projects, one or more peer entities identified among the one or more predefined entities, or both the one or more peer projects and the one or more peer entities identified;
determining one or more output values corresponding to one or more predefined output parameters of the model based on the identification, wherein the one or more predefined output parameters are associated with the one or more design thinking frameworks;
generating the one or more design thinking frameworks based on the one or more output values determined; and
providing the one or more design thinking frameworks to the user device via the network.

2. The system of claim 1, wherein the one or more design thinking frameworks are generated and provided in one or more content formats, one or more downloadable digital file formats that are compatible with one or more third-party applications respectively, or both the one or more content formats and the one or more downloadable digital file formats.

3. The system of claim 1, wherein the one or more design thinking frameworks comprise at least one of one or more design thinking related process plans, templates, digital playbooks, flow diagrams, project plans, team composition plans, project timelines, framework usage guidelines, or presentations.

4. The system of claim 1, wherein the questions provided, the responses received, or both the questions provided and the responses received relate to at least one of:
one or more problems associated with the project or one or more tasks in the project, a description of the one or more tasks respectively, one or more types of the one or more tasks, one or more development processes corresponding to the one or more tasks or the project, one or more types of the one or more development processes, one or more goals associated with the one or more tasks, a priority associated with the one or more tasks respectively, an order associated with the one or more tasks respectively, an execution stage of the project or the one or more tasks respectively, a timeline associated with the one or more tasks respectively, a timeline associated with the project, a goal associated with the project, one or more team members involved in the project or the one or more tasks, an ownership type, size, structure, an industry, and a customer segment associated with the entity, a request for information related to the one or more design thinking frameworks that is applicable to at least one of the one or more tasks, the project, or the entity, a request for the one or more design thinking frameworks corresponding to the one or more tasks or the one or more problems associated with the one or more tasks, or information related to a sponsorship of the project.

5. The system of claim 4, wherein the one or more predefined input parameters comprise at least one of:
a level of user understanding of one or more design thinking concepts, the goal of the project or the one or more tasks, the execution stage of the project or the one or more tasks, the timeline associated with the project or the one or more tasks respectively, the ownership type, the size, the structure, the industry, and the customer segment associated with the entity, the one or more team members involved in the project or the one or more tasks, the one or more development processes, or the sponsorship.

6. The system of claim 5, wherein the one or more predefined output parameters comprise at least one of:
a level of support needed for the project, one or more types of the one or more design thinking frameworks needed, a number of the one or more design thinking frameworks of each type of the one or more types needed, a number of one or more design thinking process steps to be included in the one or more design thinking frameworks of each type, an execution timeline corresponding to each process step of the one or more process steps, a number of one or more team members required to execute the project or the one or more tasks, a role of each team member of the one or more team members, or a file format of the one or more design thinking frameworks to be generated.

7. The system of claim 1, wherein the one or more functions comprise:
analyzing the one or more responses based on one or more natural language processing (NLP) machine learning models;
identifying one or more keywords based on the analysis; and
determining the one or more input values corresponding to the one or more predefined input parameters based on the identification.

8. The system of claim 1, wherein the one or more functions comprise:
receiving feedback, usage data, or both the feedback and the usage data associated with the one or more design thinking frameworks from the user device via the network;
training the model based on the feedback, the usage data, or both the feedback and the usage data;
modifying the one or more design thinking frameworks based on the trained model; and
providing the one or more modified design thinking frameworks to the user device via the network.

9. The system of claim 1, comprising a storage unit for storing the one or more input values, the one or more output values, the one or more predefined input and output parameters, the one or more predefined input values, one or more predefined output values provided corresponding to the one or more predefined output parameters, the one or more predefined projects, the one or more predefined entities, and one or more predefined design thinking frameworks, wherein the one or more predefined design thinking frameworks comprise at least one of one or more predefined design thinking related process plans, templates, digital playbooks, flow diagrams, project plans, team composition plans, project timelines, framework usage guidelines, or presentations.

10. The system of claim 9, wherein the one or more design thinking frameworks generated are different from the one or more predefined design thinking frameworks stored in the storage unit.

11. A method for incorporating one or more design thinking frameworks in a project, comprising:
providing, via a processor of a recommendation system, one or more questions associated with the project, an entity associated with the project, or both the project and the entity to a user device via a network;
receiving, via the processor, one or more responses corresponding to the one or more questions from the user device via the network;
determining, via the processor, one or more input values corresponding one or more predefined input parameters for a model based on the one or more responses;
comparing, via the processor, the one or more input values with one or more predefined input values provided corresponding to the one or more predefined input parameters, wherein the one or more predefined inputs provided are associated with one or more predefined projects, one or more predefined entities, or both the one or more predefined projects and the one or more predefined entities;
identifying, via the processor, one or more peers associated with project, the entity, or both the project and the entity based on the comparison using the model, wherein the one or more peers comprise one or more peer projects identified among the one or more predefined projects, one or more peer entities identified among the one or more predefined entities, or both the one or more peer projects and the one or more peer entities identified;
determining, via the processor, one or more output values corresponding to one or more predefined output parameters of the model based on the identification, wherein the one or more predefined output parameters are associated with the one or more design thinking frameworks;
generating, via the processor, the one or more design thinking frameworks based on the one or more output values determined; and
providing, via the processor, the one or more design thinking frameworks to the user device via the network.

12. One or more non-transitory computer-readable media having encoded thereon computer-executable instructions for performing a method for incorporating one or more design thinking frameworks in a project, the method comprising:
providing, via a processor of a recommendation system, one or more questions associated with the project, an entity associated with the project, or both the project and the entity to a user device via a network;
receiving, via the processor, one or more responses corresponding to the one or more questions from the user device via the network;
determining, via the processor, one or more input values corresponding one or more predefined input parameters for a model based on the one or more responses;
comparing, via the processor, the one or more input values with one or more predefined input values provided corresponding to the one or more predefined input parameters, wherein the one or more predefined inputs provided are associated with one or more predefined projects, one or more predefined entities, or both the one or more predefined projects and the one or more predefined entities;
identifying, via the processor, one or more peers associated with project, the entity, or both the project and the entity based on the comparison using the model, wherein the one or more peers comprise one or more peer projects identified among the one or more predefined projects, one or more peer entities identified among the one or more predefined entities, or both the one or more peer projects and the one or more peer entities identified;
determining, via the processor, one or more output values corresponding to one or more predefined output parameters of the model based on the identification, wherein the one or more predefined output parameters are associated with the one or more design thinking frameworks;
generating, via the processor, the one or more design thinking frameworks based on the one or more output values determined; and
providing, via the processor, the one or more design thinking frameworks to the user device via the network.
